(19) United States
(12) Patent Application Publication
(10) Pub. No.: US 2024/0294818 A1
(43) Pub. Date: Sep. 5, 2024

(54) HEAT-TREATMENT OIL COMPOSITION

(71) Applicant: IDEMITSU KOSAN CO.,LTD., Tokyo (JP)

(72) Inventor: Takahito SUGIURA, Chiyoda-ku (JP)

(73) Assignee: IDEMITSU KOSAN CO.,LTD., Tokyo (JP)

(21) Appl. No.: 18/569,305

(22) PCT Filed: Jun. 13, 2022
(86) PCT No.: PCT/JP2022/023556

§ 371 Date: Dec. 12, 2023

(30) Foreign Application Priority Data
Jun. 15, 2021 (JP) 2021-099601

(51) Int. Cl. C09K 5/10; C21D 1/58

(52) U.S. Cl. CPC C09K 5/10; C21D 1/58

(57) ABSTRACT

A problem is to provide a heat treating oil composition containing a sulfur compound that is excellent in brightness of a metal material after a heat treatment, such as quenching, and in storage stability. The problem is solved by a heat treating oil composition containing one or more kinds of base oils (A) selected from the group consisting of a mineral oil (A1), a synthetic oil (A2), and a vegetable oil (A3), and a sulfur compound (B), the sulfur compound (B) containing one or more kinds selected from the group consisting of a particular sulfide compound (B1), a particular sulfide compound (B2), and a particular thiazole compound (B3).

### TECHNICAL FIELD

The present invention relates to a heat treating oil composition.

### BACKGROUND ART

Metal materials, such as a steel material, may be subjected to heat treatments, such as quenching, tempering, annealing, and normalizing, for the purpose of improving the properties thereof. In these heat treatments, quenching is a treatment of immersing a heated metal material into a cooling medium to transform into the prescribed hardened structure. The metal material becomes significantly hard through the quenching, and the mechanical strength thereof is enhanced.

A heat treating oil composition has been widely used as the cooling medium for quenching. The heat treating oil composition is demanded to have a capability as a cooling medium, and also a capability of retaining the surface glossiness of the metal material before quenching even after the quenching, from the standpoint of enhancing the market value of the metal material after quenching. Accordingly, the heat treating oil composition is demanded to have a capability of improving the brightness of a metal material after quenching.

As the heat treating oil composition, for example, a heat treating oil composition having a condensed polycyclic aromatic compound, such as anthracene, blended therein has been proposed (see PTL 1).

### CITATION LIST

### Patent Literature

PTL 1: JP 2010-209422 A

### SUMMARY OF INVENTION

### Technical Problem

It has been said that in general, the brightness of a metal material after quenching is lowered with the use of a heat treating oil composition having a small sulfur content. PTL 1 uses a heat treating oil composition blended with a condensed polycyclic aromatic compound, such as anthracene, and thereby the brightness is improved even through the heat treating oil composition has a small sulfur content.

The heat treating oil composition is also demanded to have excellent storage stability. However, PTL 1 does not sufficiently investigate about the storage stability.

Under the circumstances, the present inventors have investigated about the aforementioned demands, and as a result, have found that a heat treating oil composition containing a particular sulfur compound is excellent in brightness of the metal material after a heat treatment, such as quenching, and in storage stability.

Accordingly, a problem to be solved by the present invention is to provide a heat treating oil composition containing a sulfur compound that is excellent in brightness of the metal material after a heat treatment, such as quenching, and in storage stability.

### Solution to Problem

The present invention provides the following items [1] to [3].

[1] A heat treating oil composition containing
one or more kinds of base oils (A) selected from the group consisting of a mineral oil (A1), a synthetic oil (A2), and a vegetable oil (A3), and a sulfur compound (B),
the sulfur compound (B) containing one or more kinds selected from the group consisting of a sulfide compound (B1) represented by the following general formula (b1), a sulfide compound (B2) represented by the following general formula (b2), and a thiazole compound (B3) represented by the following general formula (b3):

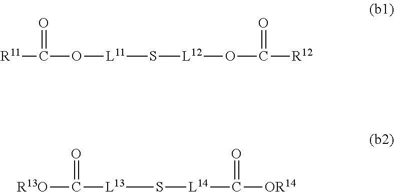

wherein in the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the general formulae (b1) and (b2), L¹¹, L¹², L¹³, and L¹⁴ each independently represent an alkylene group having 2 to 6 carbon atoms,

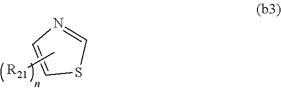

wherein in the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

[2] A method of using a heat treating oil composition, including using the heat treating oil composition according to the item [1] as a quenching oil or a tempering oil.

[3] A method of producing a heat treating oil composition, including a step of mixing one or more kinds of base oils (A) selected from the group consisting of a mineral oil (A1), a synthetic oil (A2), and a vegetable oil (A3), and a sulfur compound (B),
the sulfur compound (B) containing one or more kinds selected from the group consisting of a sulfide compound (B1) represented by the following general formula (b1), a sulfide compound (B2) represented by the following general formula (b2), and a thiazole compound (B3) represented by the following general formula (b3):

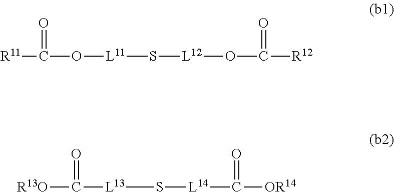

wherein in the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the general formulae (b1) and (b2), L¹¹, L¹², L¹³, and L¹⁴ each independently represent an alkylene group having 2 to 6 carbon atoms,

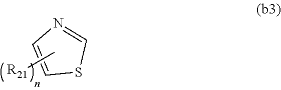

wherein in the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

### Advantageous Effects of Invention

The present invention can provide a heat treating oil composition containing a sulfur compound that is excellent in brightness of the metal material after a heat treatment, such as quenching, and in storage stability.

### BRIEF DESCRIPTION OF DRAWINGS

FIG. 1 is a diagram showing the positions of the “edge” and the “contact site” visually observed for the test piece used in the examples.

FIG. 2 is a drawing substitute photograph showing the state of the test pieces after the quenching test using the heat treating oil compositions of Examples 1 to 8 and Comparative Examples 1 to 3.

FIG. 3 is a drawing substitute photograph showing the state of the test pieces after the quenching test using the heat treating oil compositions of Comparative Examples 4 and 5 and Examples 9 and 10 (new oil and oil after 24-hour oxidative degradation).

FIG. 4 is a drawing substitute photograph showing the state of the test pieces after the quenching test using the heat treating oil compositions of Examples 9, 11, and 12 (new oil, oil after 24-hour oxidative degradation, and oil after 48-hour oxidative degradation).

FIG. 5 is a drawing substitute photograph showing the state of the test pieces after the quenching test using the heat treating oil compositions of Comparative Example 6 and Examples 13 and 14.

### DESCRIPTION OF EMBODIMENTS

In the description herein, the lower limit values and the upper limit values described in a stepwise manner for the preferred numerical ranges (such as the range of the content or the like) each may be independently combined. For example, from the description “preferably 10 to 90, and more preferably 30 to 60”, a range of “10 to 60” may be derived from the “preferred lower limit value (10)” and the “more preferred upper limit value (60)”.

In the description herein, the numerical range “lower limit value to upper limit value” means the lower limit value or more and the upper limit value or less unless otherwise indicated.

In the description herein, the numerical values in the examples can be used as the upper limit value and the lower limit value.

In the description herein, the “kinematic viscosity at 40° C.” may be referred simply to as a “40° C. kinematic viscosity”.

### [Embodiments of Heat Treating Oil Composition]

The heat treating oil composition of the present embodiment contains one or more kinds of base oils (A) selected from the group consisting of a mineral oil (A1), a synthetic oil (A2), and a vegetable oil (A3), and a sulfur compound (B).

In the heat treating oil composition of the present embodiment, the sulfur compound (B) contains one or more kinds selected from the group consisting of a sulfide compound (B1) represented by the following general formula (b1), a sulfide compound (B2) represented by the following general formula (b2), and a thiazole compound (B3) represented by the following general formula (b3):

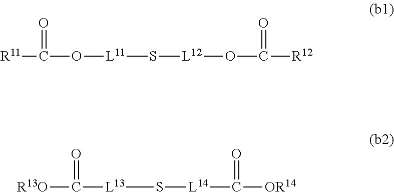

In the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms.

In the general formulae (b1) and (b2), L¹¹, L¹², L¹³, and L¹⁴ each independently represent an alkylene group having 2 to 6 carbon atoms.

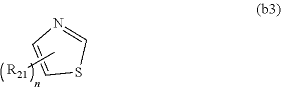

In the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

The present inventors have made earnest investigations for solving the problem. As a result, it has been found that a particular sulfide compound having an ester structure or a particular thiazole compound having a thiazole skeleton can solve the problem. Based on the knowledge, the present inventors have further made various investigations and have completed the present invention.

The heat treating oil composition of the present embodiment may be constituted only by the base oil (A) and the sulfur compound (B), and may contain an additional component other than the base oil (A) and the sulfur compound (B) in such a range that does not impair the effects of the present invention.

In the present embodiment, the total content of the base oil (A) and the sulfur compound (B) is preferably 75% by mass to 100% by mass, more preferably 80% by mass to 100% by mass, further preferably 85% by mass to 100% by mass, still further preferably 90% by mass to 100% by mass, and still much further preferably 95% by mass to 100% by mass, based on the total amount of the heat treating oil composition.

The components constituting the heat treating oil composition of the present invention will be described in detail below.

### <Base Oil (A)>

The heat treating oil composition of the present embodiment contains a base oil (A).

The base oil (A) is one or more kinds selected from the group consisting of a mineral oil (A1), a synthetic oil (A2), and a vegetable oil (A3).

The mineral oil (A1), the synthetic oil (A2), and the vegetable oil (A3) will be described in detail below.

### (Mineral Oil (A1))

The mineral oil (A1) used may be a mineral oil that has been generally used in a heat treating oil composition, with no particular limitation.

Specific examples of the mineral oil (A1) include an atmospheric residual oil obtained by subjecting a crude oil, such as a paraffin base crude oil, an intermediate base crude oil, and a naphthene base crude oil, to atmospheric distillation: a distillate oil obtained by subjecting the atmospheric residual oil to distillation under reduced pressure: a mineral oil obtained by subjecting the distillate oil to one or more treatment of solvent deasphalting, solvent extraction, hydrocracking, solvent dewaxing, catalytic dewaxing, hydro-refining, and the like; and a wax isomerization mineral oil.

The mineral oil (A1) may be a highly refined mineral oil having a reduced sulfur content obtained by performing a refining treatment including at least one kind of hydrocracking and hydro-refining.

The sulfur content of the highly refined mineral oil is preferably less than 10 ppm by mass, more preferably less than 5 ppm by mass, and further preferably less than 3 ppm by mass, based on the total amount of the highly refined mineral oil.

The mineral oil (A1) may also be a bright stock.

In the description herein, the “bright stock” means a high viscosity mineral oil (40° C. kinematic viscosity: approximately 350 mm²/s to 550 mm²/s) obtained in such a manner that an atmospheric residual oil obtained by subjecting a crude oil, such as a paraffin base crude oil, an intermediate base crude oil, and a naphthene base crude oil, to atmospheric distillation is subjected to distillation under reduced pressure to provide a distillate oil, the distillate oil is then subjected to deasphalting to provide a deasphalted oil, and the deasphalted oil is subjected to one or more kinds of refining treatments selected from solvent refining, hydro-refining, and the like.

The bright stock may be a bright stock having a small sulfur content (i.e., a hydro-refined product) or may be a bright stock having a large sulfur content.

The bright stock having a small sulfur content preferably has a sulfur content of less than 10 ppm by mass, more preferably less than 5 ppm by mass, and further preferably less than 3 ppm by mass, based on the total amount of the bright stock.

The bright stock having a large sulfur content preferably has a sulfur content of 0.30% by mass to 2.0% by mass based on the total amount of the bright stock.

The bright stock having a small sulfur content is preferably one classified into the Group II in the base oil category of American Petroleum Institute (API). The bright stock having a large sulfur content is preferably one classified into the Group I in the base oil category of American Petroleum Institute (API).

A mineral oil containing a bright stock having a large sulfur content (having a sulfur content of 0.30% by mass to 2.0% by mass based on the total amount of the bright stock) may have been blended in a heat treating oil composition from the standpoint of improving the brightness of a metal material after a heat treatment, such as quenching, by increasing the sulfur content. However, as a result of the investigations by the present inventors, it has been found that the brightness of a metal material after a heat treatment, such as quenching, may be decreased in some cases with a heat treating oil composition having a mineral oil containing a bright stock having a large sulfur content blended therein, and in particular, the brightness of a metal material after a heat treatment, such as quenching, is readily decreased in the case where the heat treatment temperature is a high temperature of 900° C. or more (particularly 950° C. or more).

According to the investigations by the present inventors, it has been confirmed that even in the case where the mineral oil (A1) containing the bright stock having a large sulfur content is used as the base oil (A) contained in the heat treating oil composition, the brightness of a metal material after a heat treatment, such as quenching, can be improved by blending the sulfur compound (B) (which is preferably one or more kinds selected from the sulfide compound (B1) and the thiazole compound (B3)).

In the heat treating oil composition of the present embodiment, the bright stock having a large sulfur content may be used by blending in the base oil (A) corresponding to the desired viscosity and the desired sulfur content required for the heat treating oil composition.

In the case where the base oil (A) contains the bright stock having a large sulfur content, the content of the bright stock having a large sulfur content is preferably 1% by mass or more, more preferably 2% by mass or more, and further preferably 3% by mass or more, based on the total amount of the base oil (A), and is preferably 20% by mass or less, more preferably 15% by mass or less, and further preferably 10% by mass or less, from the standpoint of improving the brightness of a metal material after a heat treatment, such as quenching.

The upper limit values and the lower limit values of these numerical ranges may be optionally combined. Specifically, the content thereof is preferably 1% by mass to 20% by mass, more preferably 2% by mass to 15% by mass, and further preferably 3% by mass to 10% by mass.

In the heat treating oil composition of the present embodiment, the bright stock having a small sulfur content may be used by blending in the base oil (A) corresponding to the desired viscosity required for the heat treating oil composition. In the case where the base oil (A) contains the bright stock having a small sulfur content, the content of the bright stock having a small sulfur content may be 1% by mass to 100% by mass based on the total amount of the base oil (A).

One kind of the mineral oil (A1) may be used alone, or two or more kinds thereof may be used in combination.

### (Synthetic Oil (A2))

The synthetic oil (A2) used may be a synthetic oil that has been generally used in a heat treating oil composition, with no particular limitation.

Specific examples of the synthetic oil (A2) include a poly-α-olefin compound, a polyphenyl ether, an alkylbenzene, an alkylnaphthalene, a polyphenyl-based hydrocarbon, an ester oil (for example, a fatty acid ester of a polyhydric alcohol, such as neopentyl glycol, trimethylolpropane, and pentaerythritol), a glycol-based synthetic oil, and a GTL base oil obtained by isomerizing wax produced from natural gas by the Fischer-Tropsch process or the like (GTL wax (gas-to-liquids wax)).

Among these, a GTL base oil is preferred.

One kind of the synthetic oil (A2) may be used alone, or two or more kinds thereof may be used in combination.

### (Vegetable Oil (A3))

The vegetable oil (A3) used may be a vegetable oil that has been generally used in a heat treating oil composition, with no particular limitation.

Specific examples of the vegetable oil (A3) include a linseed oil, a safflower oil, a sunflower oil, a soybean oil, a corn oil, a cotton seed oil, a sesame seed oil, an olive oil, a castor oil, a peanut oil, a coconut palm oil, a palm kernel oil, a palm oil, a coconut oil, a canola oil, and a rice bran oil.

One kind of the vegetable oil (A3) may be used alone, or two or more kinds thereof may be used in combination.

### (Preferred Embodiments of Base Oil (A))

In the present embodiment, it suffices that the base oil (A) is one or more kinds selected from the group consisting of the mineral oil (A1), the synthetic oil (A2), and the vegetable oil (A3), and is preferably one or more kinds selected from the group consisting of the mineral oil (A1) and the synthetic oil (A2).

The base oil (A) preferably contains the mineral oil (A1). In the case where the base oil (A) contains the mineral oil (A1), the content of the mineral oil (A1) is preferably 20% by mass to 100% by mass, more preferably 30% by mass to 100% by mass, further preferably 40% by mass to 100% by mass, still further preferably 50% by mass to 100% by mass, still more further preferably 60% by mass to 100% by mass, even further preferably 70% by mass to 100% by mass, even still further preferably 80% by mass to 100% by mass, and even still further preferably 90% by mass to 100% by mass, based on the total amount of the base oil (A).

### (40° C. Kinematic Viscosity of Base Oil (A))

The 40° C. kinematic viscosity of the base oil (A) used in the present embodiment is preferably 5 mm²/s to 600 mm²/s, more preferably 6 mm²/s to 570 mm²/s, further preferably 7 mm²/s to 540 mm²/s, still further preferably 8 mm²/s to 520 mm²/s, and still further preferably 9 mm²/s to 500 mm²/s.

In the case where the 40° C. kinematic viscosity of the base oil (A) is 5 mm²/s or more, a heat treating oil composition with suppressed oil smoke can be readily obtained. In the case where the 40° C. kinematic viscosity of the base oil (A) is 600 mm²/s or less, a heat treating oil composition having a good cooling capability can be readily obtained.

In the description herein, the 40° C. kinematic viscosity is a value that is measured according to JIS K2283:2000.

The heat treating oil composition of the present embodiment preferably contains multiple kinds of base oils different in 40° C. kinematic viscosity mixed with each other in consideration of the facilitation of regulation of the 40° C. kinematic viscosity of the base oil

### (A).

### (Content of Base Oil (A))

In the heat treating oil composition of the present embodiment, the content of the base oil (A) is preferably 80.0% by mass or more, more preferably 82.0% by mass or more, and further preferably 83.0% by mass or more, and is preferably 99.99% by mass or less, based on the total amount of the heat treating oil composition.

The upper limit values and the lower limit values of these numerical ranges may be optionally combined. Specifically, the content thereof is preferably 80.0% by mass to 99.99% by mass, more preferably 82.0% by mass to 99.99% by mass, and further preferably 83.0% by mass to 99.99% by mass.

### <Sulfur Compound (B)>

The heat treating oil composition of the present embodiment contains the sulfur compound (B).

In the case where the heat treating oil composition does not contain the sulfur compound (B), the brightness of a metal material after a heat treatment, such as quenching, cannot be improved.

In the present embodiment, the sulfur compound (B) contains one or more kinds selected from the group consisting of a sulfide compound (B1), a sulfide compound (B2), and a thiazole compound (B3).

In the present embodiment, the sulfur compound (B) may be formed only of one or more kinds selected from the group consisting of the sulfide compound (B1), the sulfide compound (B2), and the thiazole compound (B3), and may contain an additional sulfur compound other than the sulfide compound (B1), the sulfide compound (B2), and the thiazole compound (B3) in such a range that does not impair the effects of the present invention.

In the present embodiment, the content of one or more kinds of the compounds selected from the group consisting of the sulfide compound (B1), the sulfide compound (B2), and the thiazole compound (B3) is preferably 70% by mass to 100% by mass, more preferably 80% by mass to 100% by mass, further preferably 90% by mass to 100% by mass, and further preferably 95% by mass to 100% by mass, based on the total amount of the sulfur compound (B).

The sulfide compound (B1), the sulfide compound (B2), and the thiazole compound (B3) will be described in detail below.

### [Sulfide Compound (B1) and Sulfide Compound (B2)]

The sulfide compound (B1) is a compound represented by the following general formula (b1).

The sulfide compound (B2) is a compound represented by the following general formula (b2).

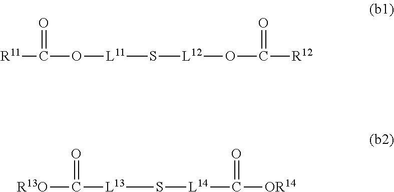

In the general formulae (b1) and (b2), R¹¹, R¹², R¹³, and R¹⁴ each independently represent a substituted or unsubstituted hydrocarbon group (X).

In the case where the hydrocarbon group (X) has a substituent, examples of the substituent include a monovalent aliphatic hydrocarbon group having 1 to 10 carbon atoms, an alkoxy group having 1 to 10 carbon atoms, a hydroxy group, an amino group, a nitro group, a carboxy group, and a halogen atom.

The monovalent aliphatic hydrocarbon group having 1 to 10 carbon atoms is preferably a linear or branched alkyl group having 3 to 10 carbon atoms, and more preferably a branched alkyl group having 3 to 10 carbon atoms.

Examples of the halogen atom include a fluorine atom, a chlorine atom, a bromine atom, and an iodine atom, in which a chlorine atom is preferred.

In the case where the hydrocarbon group (X) has a substituent, the number of the substituent may be one, or multiple substituents may exist. In the case where multiple substituents exist, the multiple substituents may be the same as or different from each other.

In the general formulae (b1) and (b2), the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms. The number of carbon atoms of the hydrocarbon group (X) does not include the number of carbon atoms of the substituent that the hydrocarbon group (X) may have.

In the case where the number of carbon atoms of the group that can be selected as the hydrocarbon group (X) exceeds 20, there is a concern that the brightness of a metal material after a heat treatment, such as quenching, is deteriorated, and there is also a concern that the storage stability is deteriorated.

Among these, an aryl group having 6 to 20 carbon atoms or an arylalkyl group having 7 to 20 carbon atoms is preferred from the standpoint of further facilitating the achievement of the effects of the present invention.

Accordingly, in the general formula (b1), it is preferred that the hydrocarbon group (X) of at least one of R¹¹ and R¹² is an aryl group having 6 to 20 carbon atoms or an arylalkyl group having 7 to 20 carbon atoms, and it is more preferred that both of them each are an aryl group having 6 to 20 carbon atoms or an arylalkyl group having 7 to 20 carbon atoms.

In the general formula (b2), it is preferred that the hydrocarbon group (X) of at least one of R¹³ and R¹⁴ is an aryl group having 6 to 20 carbon atoms or an arylalkyl group having 7 to 20 carbon atoms, and it is more preferred that both of them each are an aryl group having 6 to 20 carbon atoms or an arylalkyl group having 7 to 20 carbon atoms.

In the case where the hydrocarbon group (X) is an aryl group having 6 to 20 carbon atoms or an arylalkyl group having 7 to 20 carbon atoms, the hydrocarbon group (X) preferably has a substituent. Examples of the preferred substituent include a branched alkyl group having 3 to 10 carbon atoms and a hydroxy group, and it is more preferred that the hydrocarbon group (X) has both of these substituents. It is further preferred that the hydrocarbon group (X) has two branched alkyl groups each having 3 to 10 carbon atoms, and has one hydroxy group.

Examples of the alkyl group having 1 to 20 carbon atoms that can be selected as the hydrocarbon group (X) include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an icosyl group.

The alkyl group may be linear or branched.

The number of carbon atoms of the alkyl group is preferably 6 to 20, more preferably 8 to 20, and further preferably 10 to 20, from the standpoint of further facilitating the achievement of the effects of the present invention.

Examples of the alkenyl group having 2 to 20 carbon atoms that can be selected as the hydrocarbon group (X) include an ethenyl group, a propenyl group, a butenyl group, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, and an icosenyl group.

The alkenyl group may be linear or branched.

The number of carbon atoms of the alkenyl group is preferably 6 to 20, more preferably 8 to 20, and further preferably 10 to 20, from the standpoint of further facilitating the achievement of the effects of the present invention.

Examples of the cycloalkyl group having 3 to 20 carbon atoms that can be selected as the hydrocarbon group (X) include a cyclopropyl group, a cyclobutyl group, a cyclopentyl group, a cyclohexyl group, and a cycloheptyl group.

The expression “3 to 20 carbon atoms” in the “cycloalkyl group having 3 to 20 carbon atoms” means “3 to 20 ring carbon atoms”.

The number of carbon atoms of the cycloalkyl group is preferably 4 to 16, more preferably 5 to 10, and further preferably 5 to 6, from the standpoint of further facilitating the achievement of the effects of the present invention.

The cycloalkenyl group having 3 to 20 carbon atoms that can be selected as the hydrocarbon group (X) include a cyclopropenyl group, a cyclobutenyl group, a cyclopentenyl group, a cyclohexenyl group, and a cycloheptenyl group.

The expression “3 to 20 carbon atoms” in the “cycloalkenyl group having 3 to 20 carbon atoms” means “3 to 20 ring carbon atoms”.

The number of carbon atoms of the cycloalkenyl group is preferably 4 to 16, more preferably 5 to 10, and further preferably 5 to 6, from the standpoint of further facilitating the achievement of the effects of the present invention.

Examples of the cycloalkylalkyl group having 4 to 20 carbon atoms that can be selected as the hydrocarbon group (X) include a cyclopropylmethyl group, a cyclopropylethyl group, a cyclopropylpropyl group, a cyclopropylbutyl group, a cyclobutylmethyl group, a cyclopentylmethyl group, a cyclopentylethyl group, a cyclopentylpropyl group, a cyclohexylmethyl group, a cyclohexylethyl group, and a cyclohexylpropyl group.

The cycloalkylalkyl group is a group represented by the following general formula (c1), and is a group including an alkyl group, one hydrogen atom of which is substituted by a cycloalkyl group.

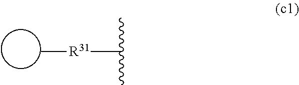

In the general formula (c1), the circle represents a cycloalkyl group, R³¹ represents an alkylene group, and the wavy line represents a bonding site to the carbon atom in the general formula (b1) or a bonding site to the oxygen atom in the general formula (b2).

The expression “4 to 20 carbon atoms” in the “cycloalkylalkyl group having 4 to 20 carbon atoms” means the total number of carbon atoms of the number of ring carbon atoms of the cycloalkyl group and the number of carbon atoms of the alkylene group (R³¹).

The number of carbon atoms (i.e., the number of ring carbon atoms) of the cycloalkyl group constituting the cycloalkylalkyl group is preferably 4 to 16, more preferably 5 to 10, and further preferably 5 to 6, from the standpoint of further facilitating the achievement of the effects of the present invention.

The number of carbon atoms of the alkylene group constituting the cycloalkylalkyl group is preferably 1 to 6, more preferably 1 to 4, and further preferably 2 to 3, from the standpoint of further facilitating the achievement of the effects of the present invention.

Examples of the cycloalkenylalkyl group having 4 to 20 carbon atoms that can be selected as the hydrocarbon group (X1) include a cyclopropenylmethyl group, a cyclopropenylethyl group, a cyclopropenylpropyl group, a cyclopropenylbutyl group, a cyclobutenylmethyl group, a cyclopentenylmethyl group, a cyclopentenylethyl group, a cyclopentenylpropyl group, a cyclohexenylmethyl group, a cyclohexenylethyl group, and a cyclohexenylpropyl group.

The cycloalkenylalkyl group is a group represented by the following general formula (c2), and is a group including an alkyl group, one hydrogen atom of which is substituted by a cycloalkenyl group.

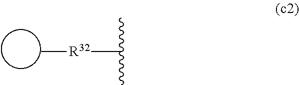

In the general formula (c2), the circle represents a cycloalkenyl group, R³² represents an alkylene group, and the wavy line represents a bonding site to the carbon atom in the general formula (b1) or a bonding site to the oxygen atom in the general formula (b2).

The expression “4 to 20 carbon atoms” in the “cycloalkenylalkyl group having 4 to 20 carbon atoms” means the total number of carbon atoms of the number of ring carbon atoms of the cycloalkenyl group and the number of carbon atoms of the alkylene group (R³²).

The number of carbon atoms (i.e., the number of ring carbon atoms) of the cycloalkenyl group constituting the cycloalkenylalkyl group is preferably 4 to 16, more preferably 5 to 10, and further preferably 5 to 6, from the standpoint of further facilitating the achievement of the effects of the present invention.

The number of carbon atoms of the alkylene group constituting the cycloalkenylalkyl group is preferably 1 to 6, more preferably 1 to 4, and further preferably 2 to 3, from the standpoint of further facilitating the achievement of the effects of the present invention.

Examples of the aryl group having 6 to 20 carbon atoms that can be selected as the hydrocarbon group (X1) include a phenyl group, a biphenylyl group, a naphthyl group, a phenanthryl group, a triphenylenyl group, a fluorenyl group, an anthryl group, a benzochrysenyl group, and a fluoranthenyl group.

The expression “6 to 20 carbon atoms” in the “aryl group having 6 to 20 carbon atoms” means “6 to 20 ring carbon atoms”.

The number of carbon atoms of the aryl group is preferably 6 to 16, more preferably 6 to 10, and further preferably 6, from the standpoint of further facilitating the achievement of the effects of the present invention.

Examples of the arylalkyl group having 7 to 20 carbon atoms that can be selected as the hydrocarbon group (X1) include a phenylmethyl group, a phenylethyl group, a phenylpropyl group, a biphenylylmethyl group, a biphenylylethyl group, a biphenylylpropyl group, a naphthylmethyl group, a naphthylethyl group, a naphthylpropyl group, a phenanthrylmethyl group, a phenanthrylethyl group, a phenanthrylpropyl group, a triphenylenylmethyl group, a triphenylenylethyl group, a triphenylenylpropyl group, a fluorenylmethyl group, a fluorenylethyl group, a fluorenylpropyl group, an anthrylmethyl group, an anthrylethyl group, an anthrylpropyl group, a benzochrysenylmethyl group, a benzochrysenylethyl group, a benzochrysenylpropyl group, a fluoranthenylmethyl group, a fluoranthenylethyl group, and a fluoranthenylpropyl group.

The arylalkyl group is a group represented by the following general formula (c3), and is a group including an alkyl group, one hydrogen atom of which is substituted by an aryl group.

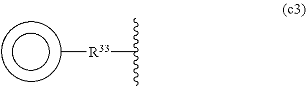

In the general formula (c3), the double circle represents an aryl group, R³³ represents an alkylene group, and the wavy line represents a bonding site to the carbon atom in the general formula (b1) or a bonding site to the oxygen atom in the general formula (b2).

The expression “7 to 20 carbon atoms” in the “arylalkyl group having 7 to 20 carbon atoms” means the total number of carbon atoms of the number of ring carbon atoms of the aryl group and the number of carbon atoms of the alkylene group (R³³).

The number of carbon atoms (i.e., the number of ring carbon atoms) of the aryl group constituting the arylalkyl group is preferably 6 to 16, more preferably 6 to 10, and further preferably 6, from the standpoint of further facilitating the achievement of the effects of the present invention.

The number of carbon atoms of the alkylene group constituting the arylalkyl group is preferably 1 to 6, more preferably 1 to 4, and further preferably 2 to 3, from the standpoint of further facilitating the achievement of the effects of the present invention.

In the general formulae (b1) and (b2), L¹¹, L¹², L¹³, and L¹⁴ each independently represent an alkylene group having 2 to 6 carbon atoms.

In the case where the number of carbon atoms of the alkylene group is 1, the brightness of the heat treating oil composition is deteriorated. In the case where the number of carbon atoms of the alkylene group is 7 or more, the compounds represented by the general formulae (b1) and (b2) are difficult to synthesize, and thus are difficult to procure.

The number of carbon atoms of the alkylene group is preferably 2 to 5, more preferably 2 to 4, and further preferably 2 to 3, from the standpoint of further facilitating the achievement of the effects of the present invention.

Among the sulfide compound (B1) and the sulfide compound (B2), the sulfide compound (B1) is preferably used from the standpoint of enhancing the brightness.

The sulfide compound (B1) preferably contains a compound represented by the following general formula (b1-1) from the standpoint of further facilitating the achievement of the effects of the present invention.

The content of the compound represented by the general formula (b1-1) is preferably 70% by mass to 100% by mass, more preferably 80% by mass to 100% by mass, further preferably 90% by mass to 100% by mass, and still further preferably 95% by mass to 100% by mass, based on the total amount of the sulfide compound (B1), from the standpoint of further facilitating the achievement of the effects of the present invention.

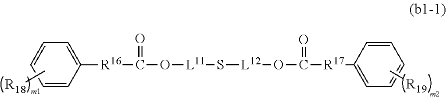

In the general formula (b1-1), R¹⁶ and R¹⁷ each independently represent an alkylene group having 1 to 6 carbon atoms.

The number of carbon atoms of the alkylene group is preferably 2 to 5, more preferably 2 to 4, and further preferably 2 to 3, from the standpoint of further facilitating the achievement of the effects of the present invention.

In the general formula (b1-1), L¹¹ and L¹² each independently represent an alkylene group having 2 to 6 carbon atoms, as similar to the general formula (b1).

In the case where the number of carbon atoms of the alkylene group is 1, the brightness of the heat treating oil composition is deteriorated. In the case where the number of carbon atoms of the alkylene group is 7 or more, the compound represented by the general formula (b1-1) is difficult to synthesize, and thus is difficult to procure.

The number of carbon atoms of the alkylene group is preferably 2 to 5, more preferably 2 to 4, and further preferably 2 to 3, from the standpoint of further facilitating the achievement of the effects of the present invention.

In the general formula (b1-1), R¹⁸ and R¹⁹ each independently represent an alkyl group having 1 to 10 carbon atoms or a hydroxy group.

The alkyl group is preferably a linear or branched alkyl group having 3 to 10 carbon atoms, and more preferably a branched alkyl group having 3 to 10 carbon atoms, from the standpoint of further facilitating the achievement of the effects of the present invention.

In the general formula (b1-1), m1 represents an integer of 0 to 5. m1 preferably represents 1 to 4, more preferably 2 to 4, and further preferably 3.

In the case where m1 represents 2 or more, multiple groups represented by R¹⁸ may be the same as or different from each other.

In the case where m1 represents 3, it is preferred that one of multiple groups represented by R¹⁸ is a hydroxy group, and the remaining two thereof each are an alkyl group having 1 to 10 carbon atoms. The alkyl group is preferably a branched alkyl group having 3 to 10 carbon atoms.

In the general formula (b1-1), m2 represents an integer of 0 to 5. m2 preferably represents 1 to 4, more preferably 2 to 4, and further preferably 3.

In the case where m2 represents 2 or more, multiple groups represented by R¹⁹ may be the same as or different from each other.

In the case where m2 represents 3, it is preferred that one of multiple groups represented by R¹⁹ is a hydroxy group, and the remaining two thereof each are an alkyl group having 1 to 10 carbon atoms. The alkyl group is preferably a branched alkyl group having 3 to 10 carbon atoms.

Specific examples of the sulfide compound (B1) include 2,2′-thiodiethylbis[3-(3,5-di-tert-butyl-4-hydroxyphenyl)propionate].

Specific examples of the sulfide compound (B2) include didodecyl 3,3′-thiodipropionate, dioctadecyl 3,3′-thiodipropionate, and ditetradecyl 3,3′-thiodipropionate.

One kind of the sulfide compound (B1) may be used alone, or two or more kinds thereof may be used in combination.

One kind of the sulfide compound (B2) may be used alone, or two or more kinds thereof may be used in combination.

In the case where the sulfide compound (B1) and the sulfide compound (B2) are used in combination, one or more kinds selected from the sulfide compound (B1) and one or more kinds selected from the sulfide compound (B2) may be used in combination.

### (Thiazole Compound (B3))

The thiazole compound (B3) is a compound represented by the following general formula (b3).

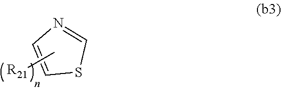

In the general formula (b3), R²¹ represents a substituted or unsubstituted hydrocarbon group (Y).

In the case where the hydrocarbon group (Y) has a substituent, examples of the substituent include a monovalent aliphatic hydrocarbon group having 1 to 10 carbon atoms, an alkoxy group having 1 to 10 carbon atoms, a hydroxy group, an amino group, a nitro group, a carboxy group, and a halogen atom.

Examples of the halogen atom include a fluorine atom, a chlorine atom, a bromine atom, and an iodine atom, in which a chlorine atom is preferred.

In the case where the hydrocarbon group (Y) has a substituent, the number of the substituent may be one, or multiple substituents may exist. In the case where multiple substituents exist, the multiple substituents may be the same as or different from each other.

In the case where the hydrocarbon group (Y) has a substituent, preferred examples of the substituent include a hydroxy group.

In the general formula (b3), the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms. The number of carbon atoms of the hydrocarbon group (Y) does not include the number of carbon atoms of the substituent that the hydrocarbon group (Y) may have.

In the case where the number of carbon atoms of the group that can be selected as the hydrocarbon group (Y) exceeds 20, there is a concern that the brightness of a metal material after a heat treatment, such as quenching, is deteriorated, and there is also a concern that the storage stability is deteriorated.

Examples of the alkyl group having 1 to 20 carbon atoms that can be selected as the hydrocarbon group (Y) include the same alkyl groups as the aforementioned alkyl groups described for the hydrocarbon group (X), and the preferred ranges thereof are also the same as the aforementioned alkyl groups.

Examples of the alkenyl group having 2 to 20 carbon atoms that can be selected as the hydrocarbon group (Y) include the same alkenyl groups as the aforementioned alkenyl groups described for the hydrocarbon group (X), and the preferred ranges thereof are also the same as the aforementioned alkenyl groups.

Examples of the cycloalkyl group having 3 to 20 carbon atoms that can be selected as the hydrocarbon group (Y) include the same alkenyl groups as the aforementioned cycloalkyl groups described for the hydrocarbon group (X), and the preferred ranges thereof are also the same as the aforementioned cycloalkyl groups.

Examples of the cycloalkylalkyl group having 4 to 20 carbon atoms that can be selected as the hydrocarbon group (Y) include the same cycloalkylalkyl groups as the aforementioned cycloalkylalkyl groups described for the hydrocarbon group (X), and the preferred ranges thereof are also the same as the aforementioned cycloalkylalkyl groups.

The cycloalkylalkyl group is a group represented by the following general formula (d1), and is a group including an alkyl group, one hydrogen atom of which is substituted by a cycloalkyl group.

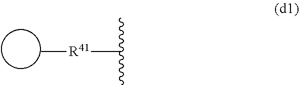

In the general formula (d1), the circle represents a cycloalkyl group, R⁴¹ represents an alkylene group, and the wavy line represents a bonding site to the 2-position, the 4-position, or the 5-position of thiazole in the general formula (b3).

Examples of the cycloalkenylalkyl group having 4 to 20 carbon atoms that can be selected as the hydrocarbon group (Y) include the same cycloalkenylalkyl groups as the aforementioned cycloalkenylalkyl groups described for the hydrocarbon group (X), and the preferred ranges thereof are also the same as the aforementioned cycloalkenylalkyl groups.

The cycloalkenylalkyl group is a group represented by the following general formula (d2), and is a group including an alkyl group, one hydrogen atom of which is substituted by a cycloalkenyl group.

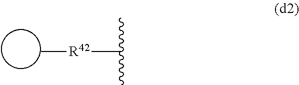

In the general formula (d2), the circle represents a cycloalkenyl group, R⁴² represents an alkylene group, and the wavy line represents a bonding site to the 2-position, the 4-position, or the 5-position of thiazole in the general formula (b3).

Examples of the aryl group having 6 to 20 carbon atoms that can be selected as the hydrocarbon group (Y) include the same aryl groups as the aforementioned aryl groups described for the hydrocarbon group (X), and the preferred ranges thereof are also the same as the aforementioned aryl groups.

Examples of the arylalkyl group having 7 to 20 carbon atoms that can be selected as the hydrocarbon group (Y) include the same arylalkyl groups as the aforementioned arylalkyl groups described for the hydrocarbon group (X), and the preferred ranges thereof are also the same as the aforementioned arylalkyl groups.

The arylalkyl group is a group represented by the following general formula (d3), and is a group including an alkyl group, one hydrogen atom of which is substituted by an aryl group.

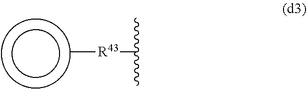

In the general formula (d3), the circle represents an aryl group, R⁴³ represents an alkylene group, and the wavy line represents a bonding site to the 2-position, the 4-position, or the 5-position of thiazole in the general formula (b3).

In the general formula (b3), n represents an integer of 0 to 3. n preferably represents 1 to 3.

In the case where n represents 2 or more, multiple groups represented by R²¹ may be the same as or different from each other.

In the case where n represents 2 or more, and two groups represented by R²¹ are adjacent to each other, the two groups represented by R²¹ may form a cyclic structure, or may not form a cyclic structure. In the case where a cyclic structure is formed, it is possible that the two groups represented by R²¹ each independently represent a group selected from an alkyl group and an alkenyl group, and an alkyl group and an alkyl group, an alkyl group and an alkenyl group, or an alkenyl group and an alkenyl group are bonded to each other to form a cycloalkyl group, a cycloalkenyl group, or an aryl group.

More specifically, in the case where the two groups represented by R²¹ form a cyclic structure in the general formula (b3), the thiazole compound (B3) may be a compound represented by the following general formula (b3-1).

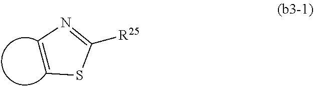

In the general formula (b3-1), the partial circle adjacent to the thiazole ring represents a cycloalkyl ring having 3 to 20 carbon atoms, a cycloalkenyl ring having 3 to 20 carbon atoms, or an aryl ring having 6 to 20 carbon atoms.

The cycloalkyl ring, the cycloalkenyl ring, and the aryl ring each may have one or more of the aforementioned substituents described as the substituent of the hydrocarbon group (Y), and may not have a substituent (i.e., may be unsubstituted).

In the general formula (b3-1), R²⁵ represents a group having the same meaning as in R²¹ in the general formula (b3), preferably an alkyl group having 1 to 20 carbon atoms, more preferably an alkyl group having 1 to 16 carbon atoms, further preferably an alkyl group having 1 to 10 carbon atoms, and still further preferably an alkyl group having 1 to 3 carbon atoms.

In the case where the two groups represented by R²¹ form a cyclic structure in the general formula (d3), the thiazole compound (B3) preferably has a molecular skeleton represented by the following structural formula (b3a) (i.e., a benzothiazole skeleton) or a molecular skeleton represented by the following structural formula (b3B) (i.e., a naphthothiazole skeleton), and preferably has a molecular skeleton represented by the following structural formula (b3a) (i.e., a benzothiazole skeleton) from the standpoint of the availability and the like.

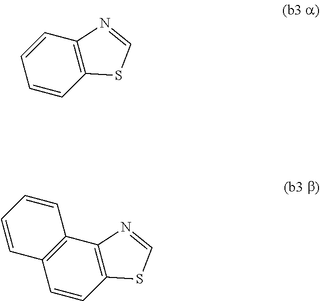 [SMILES: c1ccc2scnc2c1 ; c1ccc2c(c1)ccc1scnc12]

In the case where the thiazole compound (B3) has a molecular skeleton represented by the structural formula (b3α) or (b3β), the thiazole compound (B3) is preferably a compound represented by the following general formula (b3α-1) or the following general formula (b3β-1), and more preferably a compound represented by the following general formula (b3α-1).

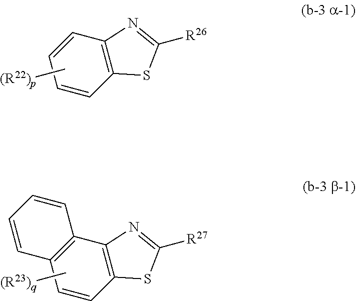

In the general formulae (b3α-1) and (b3β-1), R²⁶ and R²⁷ each represent a group having the same meaning as in R²¹ in the general formula (b3), preferably an alkyl group having 1 to 20 carbon atoms, more preferably an alkyl group having 1 to 16 carbon atoms, further preferably an alkyl group having 1 to 10 carbon atoms, and still further preferably an alkyl group having 1 to 3 carbon atoms.
p represents an integer of 0 to 4, preferably 0 to 3, more preferably 0 to 2, further preferably 0 to 1, and still further preferably 0.
q represents an integer of 0 to 6, preferably 0 to 3, more preferably 0 to 2, further preferably 0 to 1, and still further preferably 0.

In the general formula (b3α-1), R²² represents a substituent that can substitute the benzene ring constituting the benzothiazole ring. Specific examples of the substituent include the substituents described for the substituent of the hydrocarbon group (Y).

In the general formula (b3β-1), R²³ represents a substituent that can substitute the naphthalene ring constituting the naphthothiazole ring. Specific examples of the substituent include the substituents described for the substituent of the hydrocarbon group (Y).

In the case where the two groups represented by R²¹ do not form a cyclic structure, or in the case where the group represented by R²¹ is bonded to only one of the 4-position and the 5-position of the thiazole skeleton, or the groups represented by R²¹ are bonded to both the 4-position and the 5-position of the thiazole skeleton, in the general formula (b3), the thiazole compound (B3) is preferably a compound represented by the following general formula (b3γ-1).

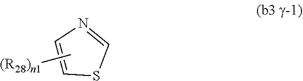

In the general formula (b3γ-1), R²⁸ represents a group having the same meaning as in R²¹ in the general formula (b3), and preferably an alkyl group having 1 to 20 carbon atoms or an aryl group having 6 to 20 carbon atoms. The group represented by R²⁸ may have the aforementioned substituent described as the substituent on the hydrocarbon group (Y), or may not have the substituent, and preferably does not have the substituent.

The number of carbon atoms of the alkyl group is more preferably 1 to 16, further preferably 1 to 10, and still further preferably 1 to 3.

The number of carbon atoms of the aryl group is more preferably 6 to 10, and further preferably 6.
n1 represents an integer of 0 to 3, preferably 1 to 3, and more preferably 2 to 3.

In the case where n1 represents 2 or more, multiple groups represented by R²⁸ may be the same as or different from each other.

In the case where n1 represents 2 or more, and two groups represented by R²⁸ are adjacent to each other, the two groups represented by R²⁸ do not form a cyclic structure.

In the general formula (b3γ-1), it is preferred that the aforementioned alkyl group is bonded as R²⁸ to the 2-position of the thiazole skeleton, and it is preferred that the aforementioned alkyl group or the aforementioned aryl group is bonded as R²⁸ to one or both of the 4-position and the 5-position of the thiazole skeleton.

Specific examples of the thiazole compound (B3) include 2-methylbenzothiazole, 2-methyl-4,5-diphenylthiazole, 2-methylnaphtho[1,2-d]thiazole, 2-(2-hydroxyphenyl)benzothiazole, 2-ethyl-4-methylthiazole, 2-phenylbenzothiazole, benzothiazole, naphtho[1,2-d]thiazole, and thiazole.

One kind of the thiazole compound (B3) may be used alone, or two or more kinds thereof may be used in combination.

### (Content of Sulfur Compound (B))

In the heat treating oil composition of the present embodiment, the content of the sulfur compound (B) is preferably 0.01% by mass or more, more preferably 0.02% by mass or more, and further preferably 0.05% by mass or more, from the standpoint of further facilitating the achievement of the effects of the present invention, and is preferably 2.0% by mass or less, more preferably 1.0% by mass or less, and further preferably 0.5% by mass or less, from the standpoint of facilitating the suppression of the formation of sludge and the decrease in lifetime of the heat treating oil composition caused by an excessive amount of the sulfur compound used, all based on the total amount of the heat treating oil composition.

The upper limit values and the lower limit values of these numerical ranges may be optionally combined. Specifically, the content thereof is preferably 0.01% by mass to 2.0% by mass, more preferably 0.02% by mass to 1.0% by mass, and further preferably 0.05% by mass to 0.5% by mass.

### (Molecular Weight of Sulfur Compound (B))

In the heat treating oil composition of the present embodiment, the molecular weight of the sulfur compound (B) is preferably 100 or more, more preferably 110 or more, and further preferably 120 or more, and is preferably 1,500 or less, more preferably 1,200 or less, and further preferably 1,000 or less, from the standpoint of further facilitating the achievement of the effects of the present invention.

The upper limit values and the lower limit values of these numerical ranges may be optionally combined. Specifically, the molecular weight thereof is preferably 100 to 1,500, more preferably 110 to 1,200, and further preferably 120 to 1,000.

### <Additives>

The heat treating oil composition of the present embodiment can be prepared by mixing the base oil (A) and the sulfur compound (B), and additives that have been ordinarily used in heat treating oil compositions may be further blended therein depending on necessity. Examples of the additives include a vapor blanket collapse agent, a brightness improver, a coolability improver, and an antioxidant.

One kind of the additives may be used alone, or two or more kinds thereof may be used in combination.

### (Vapor Blanket Collapse Agent)

Examples of the vapor blanket collapse agent include an ethylene-α-olefin copolymer (wherein the α-olefin has 3 to 20 carbon atoms), such as an ethylene-propylene copolymer: a hydrogenated product of the ethylene-α-olefin copolymer: a polymer of an α-olefin having 5 to 20 carbon atoms, such as 1-hexene, 1-octene, 1-decene, 1-dodecene, 1-tetradecene, 1-hexadecene, and 1-octadecene: a hydrogenated product of the polymer of an α-olefin: a polymer of an olefin having 3 or 4 carbon atoms, such as polypropylene, polybutene, and polyisobutylene: a hydrogenated product of the polymer of the olefin: a polymer compound, such as a polymethacrylate, a polymethacrylate, a polystyrene, and a petroleum resin; and asphalt.

One kind of the vapor blanket collapse agent may be used alone, or two or more kinds thereof may be used in combination.

The number average molecular weight (Mn) of the vapor blanket collapse agent is generally preferably 800 to 100,000. The number average molecular weight (Mn) of the vapor blanket collapse agent is a value that is measured by gel permeation chromatography (GPC) in terms of polystyrene.

The content of the vapor blanket collapse agent is preferably 0.5% by mass to 18% by mass, more preferably 1.0% by mass to 16% by mass, and further preferably 2.0% by mass to 15% by mass, based on the total amount of the heat treating oil composition.

### (Brightness Improver)

Examples of the brightness improver include fat and oil: a fat and oil fatty acid: an alkylsuccinic acid, an alkylsuccinic acid imide, an alkylsuccinic anhydride, and derivatives thereof: an alkenylsuccinic acid, an alkenylsuccinic acid imide, an alkenylsuccinic anhydride, and derivatives thereof; and a substituted hydroxy aromatic carboxylate ester and a derivative thereof.

One kind of the brightness improver may be used alone, or two or more kinds thereof may be used in combination.

The content of the brightness improver is preferably 0.1% by mass to 5.0% by mass, more preferably 0.3% by mass to 3.0% by mass, further preferably 0.4% by mass to 2.0% by mass, based on the total amount of the heat treating oil composition.

### (Coolability Improver)

Examples of the coolability improver include a metal-based detergent, such as a metal sulfonate, a metal salicylate, and a metal phenate.

Examples of the metal constituting the metal-based detergent include an alkali metal, such as sodium and potassium, and an alkaline earth metal, such as magnesium, calcium, and barium.

Examples of the coolability improver also include an imide-based dispersant, such as an alkenylsuccinic acid imide compound and a boron-containing alkenylsuccinic acid imide compound, and an amide compound of a monobasic or dibasic carboxylic acid, such as a fatty acid and succinic acid.

One kind of the coolability improver may be used alone, or two or more kinds thereof may be used in combination.

The content of the coolability improver is preferably 0.01% by mass to 8.0% by mass based on the total amount of the heat treating oil composition.

### (Antioxidant)

Examples of the antioxidant include a phenol-based antioxidant and an amine-based antioxidant.

Examples of the phenol-based antioxidant include a monocyclic phenol compound, such as 2,6-di-tert-butyl-p-cresol, 2,6-di-tert-butyl-4-ethylphenol, 2,4,6-tri-tert-butylphenol, 2,6-di-tert-butyl-4-hydroxymethylphenol, 2,6-di-tert-butylphenol, 2,4-dimethyl-6-tert-butylphenol, 2,6-di-tert-butyl-4-(N,N-dimethylaminomethyl)phenol, 2,6-di-tert-amyl-4-methylphenol, and n-octadecyl-3-(4-hydroxy-3,5-di-tert-butylphenyl) propionate; and a polycyclic phenol compound, such as 4,4′-methylenebis(2,6-di-tert-butylphenol), 4,4′-isopropylidenebis(2,6-di-tert-butylphenol), 2,2′-methylenebis(4-methyl-6-tert-butylphenol), 4,4′-bis(2,6-di-tert-butylphenol), 4,4′-bis(2-methyl-6-tert-butylphenol), 2,2′-methylenebis(4-ethyl-6-tert-butylphenol), 4,4′-butylidenebis(3-methyl-6-tert-butylphenol), 2,2′-thiobis(4-methyl-6-tert-butylphenol), and 4,4′-thiobis(3-methyl-6-tert-butylphenol).

Examples of the amine-based antioxidant include a diphenylamine-based antioxidant and a naphthylamine-based antioxidant.

Examples of the diphenylamine-based antioxidant include an alkylated diphenylamine having an alkyl group having 3 to 20 carbon atoms, and specific examples thereof include diphenylamine, monooctyldiphenylamine, monononyldiphenylamine, 4,4′-dibutyldiphenylamine, 4,4′-dihexyldiphenylamine, 4,4′-dioctyldiphenylamine, 4,4′-dinonyldiphenylamine, tetrabutyldiphenylamine, tetrahexyldiphenylamine, tetraoctyldiphenylamine, and tetranonyldiphenylamine.

Examples of the naphthylamine-based antioxidant include a phenyl-α-naphthylamine substituted by an alkyl group having 3 to 20 carbon atoms, and specific examples thereof include α-naphthylamine, phenyl-α-naphthylamine, butylphenyl-α-naphthylamine, hexylphenyl-α-naphthylamine, octylphenyl-α-naphthylamine, and nonylphenyl-α-naphthylamine.

One kind of the antioxidant may be used alone, or as two or more kinds thereof may be used in combination.

The antioxidant preferably contains an amine-based antioxidant, and more preferably is formed of an amine-based antioxidant, from the standpoint of suppressing the oxidative degradation and retaining good brightness for a long period of time. The amine-based antioxidant preferably contains a diphenylamine-based antioxidant, and more preferably is formed of a diphenylamine-based antioxidant.

The content of the antioxidant is preferably 0.01% by mass to 5.0% by mass, more preferably 0.02% by mass to 3.0% by mass, and further preferably 0.05% by mass to 2.0% by mass, based on the total amount of the heat treating oil composition.

(Additional Sulfur Compound Other than Sulfide Compound (B1), Sulfide Compound (B2), and Thiazole Compound (B3))

In the heat treating oil composition of the present embodiment, the sulfur compound (B) may contain an additional sulfur compound other than the sulfide compound (B1), the sulfide compound (B2), and the thiazole compound (B3), and the amount of the additional sulfur compound is preferably small from the standpoint of further facilitating the achievement of the effects of the present invention.

Examples of the additional sulfur compound include a sulfone compound and a sulfide compound having no ester structure.

In the heat treating oil composition of the present embodiment, the content of the sulfone compound and the sulfide compound having no ester structure each independently are preferably less than 0.20% by mass, more preferably less than 0.10% by mass, further preferably less than 0.01% by mass, and still further preferably less than 0.001% by mass, and it is still much further preferred that these compounds are not contained.

### [Property Values of Heat Treating Oil Composition of Present Invention]

### <Sulfur Content>

The sulfur content of the heat treating oil composition of the present embodiment is preferably 10 ppm by mass or more, more preferably 20 ppm by mass or more, and further preferably 25 ppm by mass or more, and is preferably 5,000 ppm by mass or less, more preferably 3,500 ppm by mass or less, and further preferably 2,500 ppm by mass or less, based on the total amount of the heat treating oil composition.

The upper limit values and the lower limit values of these numerical ranges may be optionally combined. Specifically, the content thereof is preferably 10 ppm by mass to 5,000 ppm by mass, more preferably 20 ppm by mass to 3,500 ppm by mass, and further preferably 25 ppm by mass to 2,500 ppm by mass.

In the description herein, the content of sulfur in the heat treating oil composition means a value that is measured according to the ultraviolet fluorescence method of JIS K2541-6:2013 for values in the ppm by mass order, and means a value that is measured according to the wavelength dispersion fluorescent X-ray method of JIS K2541-7:2013 for values in the percent by mass order.

### <Phosphorus Amount, Molybdenum Amount, and Zinc Amount>

The phosphorus amount, the molybdenum amount, and the zinc amount of the heat treating oil composition of the present embodiment each independently are preferably less than 0.01% by mass, and more preferably 0.001% by mass, based on the total amount of the heat treating oil composition, and it is further preferred that phosphorus, molybdenum, and zinc are not contained.

In the description herein, the phosphorus amount, the molybdenum amount, and the zinc amount of the heat treating oil composition can be measured according to JPI-5S-38-03.

### <40° C. Kinematic Viscosity>

The 40° C. kinematic viscosity of the heat treating oil composition of the present embodiment is set corresponding to the target oil temperature in a heat treatment, such as quenching.

A heat treating oil composition is classified into a cold oil used at a low oil temperature, a hot oil used at a high oil temperature, and a semi-hot oil used at an oil temperature therebetween. The cold oil is classified into Type 1 of JIS K2242:2012, and the semi-hot oil and the hot oil are classified into Type 2 of JIS K2242:2012.

In the case where the heat treating oil composition of the present embodiment is used as a cold oil, the 40° C. kinematic viscosity thereof is preferably 5 mm²/s or more and less than 40 mm²/s.

In the case where the heat treating oil composition of the present embodiment is used as a semi-hot oil or a hot oil, the 40° C. kinematic viscosity thereof is more preferably 40 mm²/s or more and 500 mm²/s or less.

In the description herein, the 40° C. kinematic viscosity of the heat treating oil composition means a value that is measured according to JIS K2283:2000.

### [Method of Producing Heat Treating Oil Composition]

The method of producing the heat treating oil composition of the present embodiment is not particularly limited.

For example, the method of producing a heat treating oil composition of the present embodiment includes a step of mixing one or more kinds of base oils (A) selected from the group consisting of a mineral oil (A1), a synthetic oil (A2), and a vegetable oil (A3), and a sulfur compound (B).

The sulfur compound (B) contains one or more kinds selected from the group consisting of a sulfide compound (B1) represented by the following general formula (b1), a sulfide compound (B2) represented by the following general formula (b2), and a thiazole compound (B3) represented by the following general formula (b3).

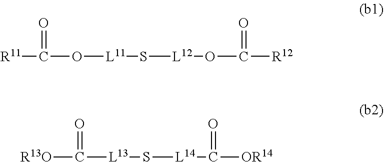

In the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms.

In the general formulae (b1) and (b2), L¹¹, L¹², L¹³, and L¹⁴ each independently represent an alkylene group having 2 to 6 carbon atoms.

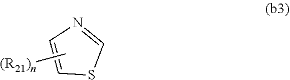

In the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

The method of mixing the components is not particularly limited, and examples thereof include a step of blending the sulfur compound (B) with the base oil (A). In the case where the heat treating oil composition further contains an additional component (e.g., the additives described above) other than the base oil (A) and the sulfur compound (B), the additional component may be blended simultaneously with the sulfur compound (B) with the base oil (A), and may be blended separately therefrom. The components each may be blended in the form of a solution (dispersion) by adding a diluent oil or the like. After blending the components, the components are preferably agitated by a known method for dispersing uniformly.

The preferred embodiments of the base oil (A) and the sulfur compound (B) have been described above.

### [Applications of Heat Treating Oil Composition]

The heat treating oil composition of the present embodiment can be used in a heat treatment, such as quenching, of a metal material, and thereby the brightness of the metal material after the heat treatment, such as quenching, can be improved. For example, the heat treating oil composition can be favorably used as a heat treating oil composition in performing a heat treatment, such as quenching, of various alloy steels, such as a carbon steel, a nickel-manganese steel, a chromium-molybdenum steel, and a manganese steel.

The heat treating oil composition of the present embodiment is also excellent in storage stability.

Accordingly, the heat treating oil composition of the present embodiment is preferably used as a heat treatment oil for quenching or the like of a metal material (preferably a quenching oil or a tempering oil). Furthermore, the present embodiment also provides a method of using a heat treating oil composition, including using the heat treating oil composition of the present embodiment as a heat treatment oil for quenching or the like of a metal material (preferably a quenching oil or a tempering oil). The oil temperature of the heat treating oil composition in the case where the heat treatment is quenching is preferably set to 40° C. to 280° C., more preferably 50° C. to 200° C., and further preferably 60° C. to 150° C. In the case where the heat treatment is tempering, the oil temperature may be further increased, and the upper limit thereof may be, for example, 300° C. The heating temperature of the metal material may be 800° C. or more and 900° C. or less, and may be more than 900° C. and 1,100° C. or less. The heat treating oil composition of the present embodiment can improve the brightness of the metal material after quenching even in the case where the heating temperature of the metal material is more than 900° C. and 1,100° C. or less.

### Embodiments Provided by Present Invention

The present invention provides embodiments of the following items [1] to [10].

[1] A heat treating oil composition containing
one or more kinds of base oils (A) selected from the group consisting of a mineral oil (A1), a synthetic oil (A2), and a vegetable oil (A3), and a sulfur compound (B),
the sulfur compound (B) containing one or more kinds selected from the group consisting of a sulfide compound (B1) represented by the following general formula (b1), a sulfide compound (B2) represented by the following general formula (b2), and a thiazole compound (B3) represented by the following general formula (b3):

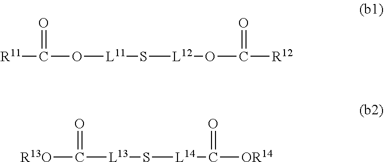

wherein in the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the general formulae (b1) and (b2), L¹¹, L¹², L¹³, and L¹⁴ each independently represent an alkylene group having 2 to 6 carbon atoms,

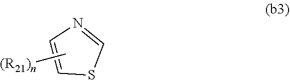

wherein in the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

[2] The heat treating oil composition according to the item [1], wherein in the general formula (b1), the hydrocarbon group (X) of at least one of R¹¹ and R¹² is an aryl group having 6 to 20 carbon atoms or an arylalkyl group having 7 to 20 carbon atoms.

[3] The heat treating oil composition according to the item [1] or [2], wherein the sulfide compound (B1) contains a sulfide compound (B1-1) represented by the following general formula (b1-1):

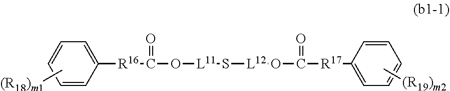

wherein in the general formula (b1-1), R¹⁶ and R¹⁷ each independently represent an alkylene group having 1 to 6 carbon atoms,
L¹¹ and L¹² each independently represent an alkylene group having 2 to 6 carbon atoms, R¹⁸ and R¹⁹ each independently represent an alkyl group having 1 to 10 carbon atoms or a hydroxy group,
m1 represents an integer of 0 to 5,
m2 represents an integer of 0 to 5,
in the case where m1 represents 2 or more, multiple groups represented by R¹⁸ may be the same as or different from each other, and
in the case where m2 represents 2 or more, multiple groups represented by R¹⁹ may be the same as or different from each other.

[4] The heat treating oil composition according to any one of the items [1] to [3], wherein the thiazole compound (B3) has a molecular skeleton represented by the following structural formula (b3α) or the following structural formula (b3β):

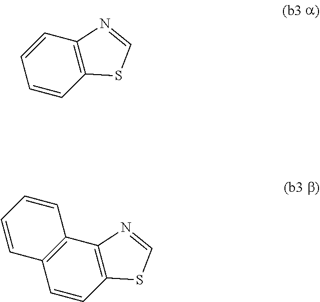 [SMILES: c1ccc2scnc2c1 ; c1ccc2c(c1)ccc1scnc12]

[5] The heat treating oil composition according to any one of the items [1] to [4], wherein the heat treating oil composition has a sulfur content of 10 ppm by mass to 5,000 ppm by mass based on the total amount of the heat treating oil composition.

[6] The heat treating oil composition according to any one of the items [1] to [5], wherein the heat treating oil composition has a content of the sulfur compound (B) of 0.01% by mass to 2.0% by mass based on the total amount of the heat treating oil composition.

[7] The heat treating oil composition according to any one of the items [1] to [6], in which the heat treating oil composition further contains one or more kinds selected from the group consisting of a vapor blanket collapse agent, a brightness improver, a coolability improver, and an antioxidant.

[8] The heat treating oil composition according to any one of the items [1] to [7], wherein the heat treating oil composition is used as a quenching oil or a tempering oil.

[9] A method of using a heat treating oil composition, including using the heat treating oil composition according to any of the items [1] to [7] as a quenching oil or a tempering oil.

[10] A method of producing a heat treating oil composition, including a step of mixing one or more kinds of base oils (A) selected from the group consisting of a mineral oil (A1), a synthetic oil (A2), and a vegetable oil (A3), and a sulfur compound (B),
the sulfur compound (B) containing one or more kinds selected from the group consisting of a sulfide compound (B1) represented by the following general formula (b1), a sulfide compound (B2) represented by the following general formula (b2), and a thiazole compound (B3) represented by the following general formula (b3):

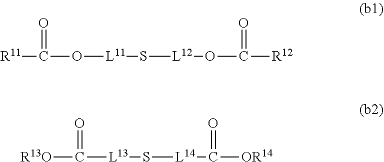

wherein in the general formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the general formulae (b1) and (b2), L¹¹, L¹², L¹³, and L¹⁴ each independently represent an alkylene group having 2 to 6 carbon atoms,

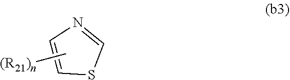

wherein in the general formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
n represents an integer of 0 to 3,
in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

### EXAMPLES

The present invention will be described more specifically with reference to examples below, but the present invention is not limited to the following examples.

### [Measurement Method of Property Values]

### (1) 40° C. Kinematic Viscosity of Base Oil (A) and Heat Treating Oil Composition

The base oils (A) used in Examples and Comparative Examples and the heat treating oil compositions prepared in Examples and Comparative Examples were measured for the 40° C. kinematic viscosity according to JIS K2283:2000.

### (2) Sulfur Content

The base oils (A) used in Examples and Comparative Examples and the heat treating oil compositions prepared in Examples and Comparative Examples were measured for the sulfur content according to the ultraviolet fluorescent method of JIS K2541-6:2013 for the measurement of values in the ppm by mass order, or according to the wavelength dispersive X-ray spectroscopy of JIS K2541-7:2013 for the measurement of values in the percent by mass order.

### Examples 1 to 14 and Comparative Examples 1 to 6

The raw materials used for preparing the heat treating oil compositions of Examples 1 to 14 and Comparative Examples 1 to 6 are shown below.

### (1) Base Oil (A)

### Mineral Oil (A1)-1:

High viscosity mineral oil classified into Group II of API Category (corresponding to the bright stock having a small sulfur content), sulfur amount: less than 3 ppm by mass, 40° C. kinematic viscosity: 396.7 mm²/s

### Mineral Oil (A1)-2:

Mineral oil classified into Group II of API Category, sulfur amount: less than 3 ppm by mass, 40° C. kinematic viscosity: 7.573 mm²/s

### Mineral Oil (A1)-3:

Mineral oil classified into Group III of API Category, sulfur amount: less than 3 ppm by mass, 40° C. kinematic viscosity: 20.57 mm²/s

### Mineral Oil (A1)-4:

Mineral oil classified into Group II of API Category, sulfur amount: less than 3 ppm by mass, 40° C. kinematic viscosity: 31.49 mm²/s

### Mineral Oil (A1)-5:

Mineral oil classified into Group III of API Category, sulfur amount: less than 3 ppm by mass, 40° C. kinematic viscosity: 12.53 mm²/s

### Mineral Oil (A1)-6:

High viscosity mineral oil classified into Group I of API Category (corresponding to the bright stock having a small sulfur content), sulfur amount: 1.01% by mass, 40° C. kinematic viscosity: 481.8 mm²/s

### (2) Sulfur Compound (B)

### Sulfide Compound (B1)-1:

2,2′-Thiodiethylbis[3-(3,5-di-tert-butyl-4-hydroxyphenyl)propionate] weight: 642.94) (molecular

Compound represented by the following chemical formula (b1-1-1)

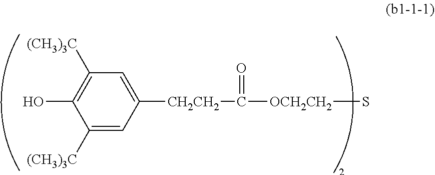

The compound represented by the chemical formula (b1-1-1) is a compound represented by the general formula (b1-1), wherein R¹⁶ and R¹⁷ each represent an ethylene group, L¹¹ and L¹² each represent an ethylene group, m1=3, in which one of the groups represented by R¹⁸ is a hydroxy group (substitution position: 4-position), and two thereof each are a tert-butyl group (substitution positions: 3-position and 5-position), and m2=3, in which one of the groups represented by R¹⁹ is a hydroxy group (substitution position: 4-position), and two thereof each are a tert-butyl group (substitution positions: 3-position and 5-position).

### Sulfide Compound (B2)-1:

Didodecyl 3,3′-thiodipropionate (molecular weight: 514.85)

The compound is a compound represented by the following chemical formula (b2-1).

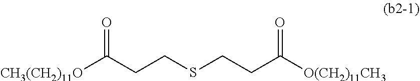

The compound represented by the chemical formula (b2-1) is a compound represented by the general formula (b2), wherein L¹³ and L¹⁴ each represent an ethylene group, and R¹³ and R¹⁴ each represent an n-dodecyl group.

### Thiazole Compound (B3)-1:

2-Methylbenzothiazole (molecular weight: 149.21)

The compound is a compound represented by the following chemical formula (b3-1).

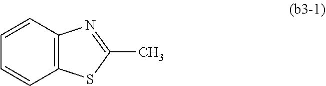

The compound represented by the chemical formula (b3-1) is a compound represented by the general formula (b3), wherein n=3, in which one of the groups represented by R²¹ is a methyl group (substitution position: 2-position of thiazole), and two substituents (substitution positions: 4-position and 5-position of thiazole) form a benzene ring. Accordingly, the compound represented by the chemical formula (b3-1) has a molecular skeleton represented by the structural formula (b3α), and is also a compound represented by the general formula (b3α-1).

### Thiazole Compound (B3)-2:

2-Methyl-4,5-diphenylthiazole (molecular weight: 251.35)

The compound is a compound represented by the following chemical formula (b3-2).

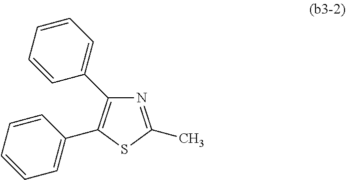 [SMILES: Cc1nc(-c2ccccc2)c(-c2ccccc2)s1]

The compound represented by the chemical formula (b3-2) is a compound represented by the general formula (b3), wherein n=3, in which one of the groups represented by R²¹ is a methyl group (substitution position: 2-position of thiazole), and two substituents (substitution positions: 4-position and 5-position of thiazole) each are a phenyl group. The compound represented by the chemical formula (b3-2) does not have a cyclic structure formed with two groups represented by R²¹, and therefore is also a compound represented by the general formula (b3γ-1).

### Thiazole Compound (B3)-3:

2-Methylnaphtho[1,2-d]thiazole (molecular weight: 199.27)

The compound is a compound represented by the following chemical formula (b3-3).

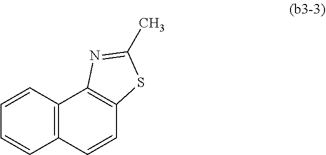

The compound represented by the chemical formula (b3-3) is a compound represented by the general formula (b3), wherein n=3, in which one of the groups represented by R²¹ is a methyl group (substitution position: 2-position of thiazole), and two substituents (substitution positions: 4-position and 5-position of thiazole) form a naphthalene ring. Accordingly, the compound represented by the chemical formula (b3-3) has a molecular skeleton represented by the structural formula (b3β), and is also a compound represented by the general formula (b3β-1).

### Thiazole Compound (B3)-4:

2-(2-Hydroxyphenyl)benzothiazole (molecular weight: 227.28)

The compound is a compound represented by the following chemical formula (b3-4).

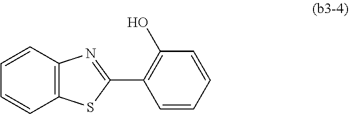 [SMILES: Oc1ccccc1-c1nc2ccccc2s1]

The compound represented by the chemical formula (b3-4) is a compound represented by the general formula (b3), wherein n=3, in which one of the groups represented by R²¹ is a hydroxyphenyl group (substitution position: 2-position of thiazole), and two substituents (substitution positions: 4-position and 5-position of thiazole) form a benzene ring. Accordingly, the compound represented by the chemical formula (b3-4) has a molecular skeleton represented by the structural formula (b3α), and is also a compound represented by the general formula (b3α-1).

### Thiazole Compound (B3)-5:

2-Ethyl-4-methylthiazole (molecular weight: 127.21)

The compound is a compound represented by the following chemical formula (b3-5).

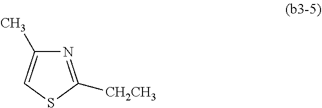

The compound represented by the chemical formula (b3-5) is a compound represented by the general formula (b3), wherein n=2, in which one of the groups represented by R²¹ is an ethyl group (substitution position: 2-position of thiazole), and the other one thereof is a methyl group (substitution position: 4-position of thiazole). The compound represented by the chemical formula (b3-5) does not have a substituent at the 5-position of thiazole, and does not form a cyclic structure formed with two groups represented by R²¹, and therefore the compound is also a compound represented by the general formula (b3γ-1).

### Thiazole Compound (B3)-6:

2-Phenylbenzothiazole (molecular weight: 211.28)

The compound is a compound represented by the following chemical formula (b3-6).

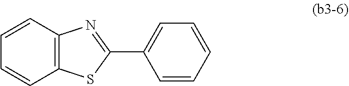 [SMILES: c1ccc(-c2nc3ccccc3s2)cc1]

The compound represented by the chemical formula (b3-6) is a compound represented by the general formula (b3), wherein n=3, in which one of the groups represented by R²¹ is a phenyl group (substitution position: 2-position of thiazole), and two substituents (substitution positions: 4-position and 5-position of thiazole) form a benzene ring. Accordingly, the compound represented by the chemical formula (b3-6) has a molecular skeleton represented by the structural formula (b3α), and is also a compound represented by the general formula (b3α-1).

### (3) Comparative Sulfur Compound

### Sulfur Compound (B′)-1:

4,4′-Thiobis(6-tert-butyl-m-cresol) (molecular weight: 358.54)

The compound is a sulfide compound having no ester structure represented by the following chemical formula (b′-1).

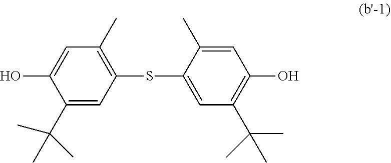 [SMILES: Cc1cc(O)c(C(C)(C)C)cc1Sc1cc(C(C)(C)C)c(O)cc1C]

### Sulfur Compound (B′)-2:

Diphenyl sulfone (molecular weight: 218.27)

The compound is a sulfone compound represented by the following chemical formula (b′-2).

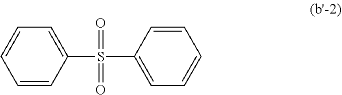 [SMILES: O=S(=O)(c1ccccc1)c1ccccc1]

### Sulfur Compound (B′)-3:

Dibenzothiophene (molecular weight: 184.26)

The compound is a thiophene compound represented by the following chemical formula (b′-3).

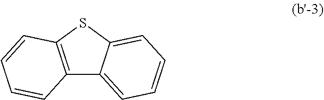 [SMILES: c1ccc2c(c1)sc1ccccc12]

### (4) Additives

Vapor blanket collapse agent: polymer
Brightness improver: carboxylic acid
Amine-based antioxidant: diphenylamine-based antioxidant
Phenol-based antioxidant: 2,6-di-tert-butyl-p-cresol

The raw materials were sufficiently mixed in the blending amounts (% by mass) shown in Tables 1 to 4, so as to prepare the heat treating oil compositions of Examples 1 to 14 and Comparative Examples 1 to 6.

### Evaluation Methods

### (1) Evaluation Method of Brightness

The brightness of the steel material after quenching was evaluated with reference to “Influence of Oxygen in Heat treating oil Tank on Brightness (Idemitsu Tribo Review, No. 31, pp. 1963-1966, published on September 30, Heisei 20 (2008)).

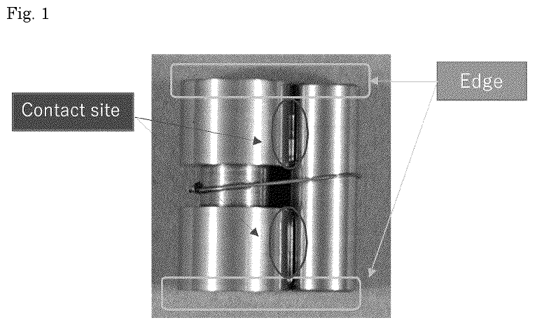

Specifically, a dumbbell specimen of S45C Steel (diameter: 16 mm, length: 30 mm, hardness HRC: 16) and a cylindrical specimen of SUJ2 Steel (diameter: 10 mm, length: 30 mm, hardness HRC: 15) were combined to prepare a test piece. In more detail, the dumbbell specimen of S45C Steel and the cylindrical specimen of SUJ2 Steel were banded by tying with a SUS 303 wire at the center (see FIG. 1).

The “S45C Steel” is a carbon steel described in JIS G 4051. The “SUJ2 Steel” is a high carbon chromium bearing steel described in JIS G 4805. The “SUS 303 wire” is a stainless steel wire described in JIS G 4039.

A quenching test was performed in such a manner that the test piece was heated in a furnace having a mixed gas atmosphere of nitrogen and hydrogen, and then the test piece was quenched by placing in the heat treating oil composition.

The conditions of the quenching test were the following three conditions.

### (Quenching Test Condition 1: Hot Oil Assumed Test, Table 1)

Test object: Comparative Examples 1 to 3 and Examples 1 to 8
Furnace temperature: 850° C.
Test piece retention time in furnace: 40 minutes after furnace temperature reached 850° C.
Temperature of heat treating oil composition: 120° C.
Immersion time of test piece in heat treating oil composition (quenching time): 10 minutes

### (Quenching Test Condition 2: Cold Oil Assumed Test 1, Tables 2 and 3)

Test object: Comparative Examples 4 and 5 and Examples 9 to 12
Furnace temperature: 850° C.
Test piece retention time in furnace: 40 minutes after furnace temperature reached 850° C.
Temperature of heat treating oil composition: 80° C.
Immersion time of test piece in heat treating oil composition (quenching time): 10 minutes

### (Quenching Test Condition 3: Cold Oil Assumed Test 2, Table 4)

Test object: Comparative Example 6 and Examples 13 and 14
Furnace temperature: 975° C.
Test piece retention time in furnace: 40 minutes after furnace temperature reached 975° C.
Temperature of heat treating oil composition: 60° C.
Immersion time of test piece in heat treating oil composition (quenching time): 10 minutes

The test piece after quenching was evaluated for brightness focusing on the “coloration degree”, the “coloration at edge”, and the “coloration at contact site” based on the following standard. The brightness of the test piece was comprehensively evaluated by the following standard based on the evaluation results of the “coloration degree”, the “coloration at edge”, and the “coloration at contact site”.

### (Coloration Degree)

An appearance sample having been colored as prescribed was produced, and the color of the quenched test piece was evaluated by visually comparing therewith. The extent of coloration of the appearance sample is shown by the following numerals.
0: No coloration was observed.
1: Pale coloration was observed.
2: Blackish brown to black coloration was observed.

### (Coloration at Edge)

The edge of the test piece (see FIG. 1) was visually observed and evaluated by the following standard.
0: No or substantially no coloration was observed.
1: Pale coloration was observed.
2: Blackish brown to black coloration was observed.

### (Coloration at Contact Site)

The contact site of the test piece (i.e., the contact site of the dumbbell steel specimen and the cylindrical steel specimen, see FIG. 1) was visually observed and evaluated by the following standard.
0: No or substantially no coloration was observed.
1: Pale coloration was observed.
2: Blackish brown to black coloration was observed.

### (Comprehensive Evaluation of Brightness)

The comprehensive evaluation was performed by using the evaluation results of the “coloration degree”, the “coloration at edge”, and the “coloration at contact site” based on the following standard.
Evaluation S: The sum of the evaluation results of the “coloration degree”, the “coloration at edge”, and the “coloration at contact site” was 0.
Evaluation A: The sum of the evaluation results of the “coloration degree”, the “coloration at edge”, and the “coloration at contact site” was 1.
Evaluation B: The sum of the evaluation results of the “coloration degree”, the “coloration at edge”, and the “coloration at contact site” was 2.
Evaluation C: The sum of the evaluation results of the “coloration degree”, the “coloration at edge”, and the “coloration at contact site” was 3 or more.

In the case where the evaluation result of any of the “coloration degree”, the “coloration at edge”, and the “coloration at contact site” was 2 or more, the evaluation was designated as C.

The heat treating oil composition of the evaluation S is significantly excellent in brightness. The heat treating oil composition of the evaluation A is excellent in brightness. The heat treating oil composition of the evaluation B is slightly inferior in brightness. The heat treating oil composition of the evaluation C is inferior in brightness.

### (2) Evaluation Method of Storage Stability

In a colorless transparent glass container of 1,000 mL, the heat treating oil composition was collected in an amount corresponding to approximately 80% of the capacity of the glass container, and allowed to stand in an environment away from direct sunlight at room temperature (25° C.) for one month.

After allowing to stand for one month, the heat treating oil composition in the glass container was visually observed and evaluated by the following standard. In the examples, “good” was regarded as acceptable.
Good: No deposit was observed.
Light: A deposit was observed to the extent that the entire bottom of the glass container was not covered.
Medium: A deposit was observed to the extent that the entire bottom of the glass container was thinly covered.
Heavy: A layered deposit was observed.

### (3) Oxidative Degradation Test

The heat treating oil composition was subjected to oxidative degradation in the following manner with reference to JIS K2242:2012, “6.3 Stability Test Method”.

400 mL of the heat treating oil was charged in a container having a capacity of 730 mL (45 mm in diameter×500 mm in length) with no catalyst charged therein, and subjected to oxidative degradation at a temperature of 170° C. and an air flow rate of 10 L/hour for 24 hours or 48 hours.

The heat treating oil composition that was not subjected to oxidative degradation (which may be hereinafter referred to as a “new oil”) and the heat treating oil composition after subjecting to the oxidative degradation were measured for the 40° C. kinematic viscosity, and evaluated for the brightness according to the section “(1) Evaluation Method of Brightness”. The increment rate of the 40° C. kinematic viscosity after the oxidative degradation (i.e., the increment rate of 40° C. kinematic viscosity from the new oil) was calculated according to the following expression.

$$( Increment rate of 40 ° C . kinematic viscosity from new oil ) = ( [ 40 ° C . kinematic viscosity after oxidative degradation ) - ( 40 ° C . kinematic viscosity of new oil ) ] / ( 40 ° C . kinematic viscosity of new oil )$$

A larger increment rate of 40° C. kinematic viscosity from the new oil means that the oxidative degradation of the heat treating oil composition more likely proceeds, and in other words, means that the heat treating oil composition has lower oxidation stability. In contrast, a smaller increment rate of 40° C. kinematic viscosity from the new oil means that the oxidative degradation of the heat treating oil composition less likely proceeds, and in other words, means that the heat treating oil composition has higher oxidation stability. As for the brightness, smaller deterioration thereof as compared to before the forced degradation means a better heat treating oil composition.

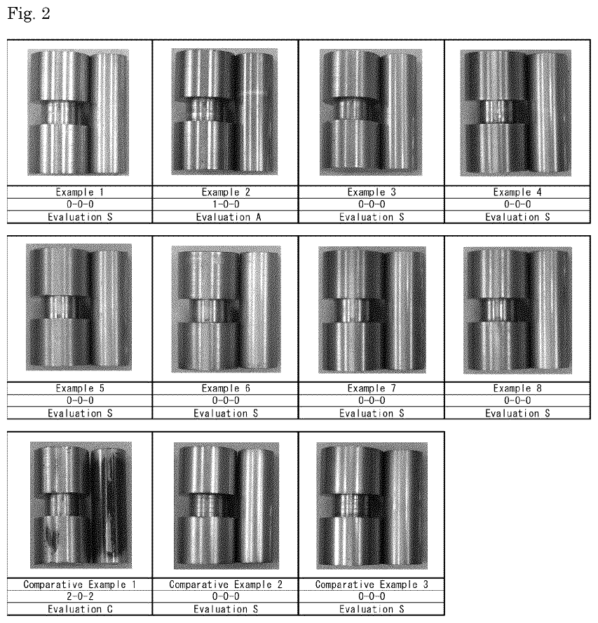

Table 1 shows the results of the evaluation of the brightness and the evaluation of the storage stability for the heat treating oil compositions of Examples 1 to 8 and Comparative Examples 1 to 3. FIG. 2 shows the state of the test pieces after the quenching test using the heat treating oil compositions of Examples 1 to 8 and Comparative Examples 1 to 3.

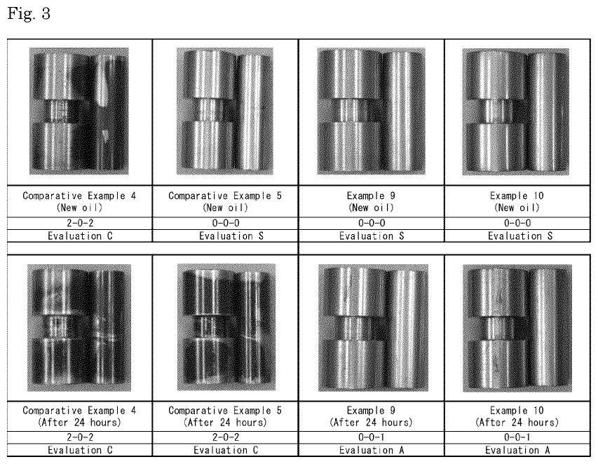

Table 2 shows the results of the measurement of the 40° C. kinematic viscosity and the evaluation of the brightness for the heat treating oil compositions of Comparative Examples 4 and 5 and Examples 9 and 10. Table 2 shows the results of the new oils and the results of the oil after subjecting to the 24-hour oxidative degradation test for the heat treating oil compositions. FIG. 3 shows the state of the test pieces after the quenching test using the heat treating oil compositions of Comparative Examples 4 and 5 and Examples 9 and 10.

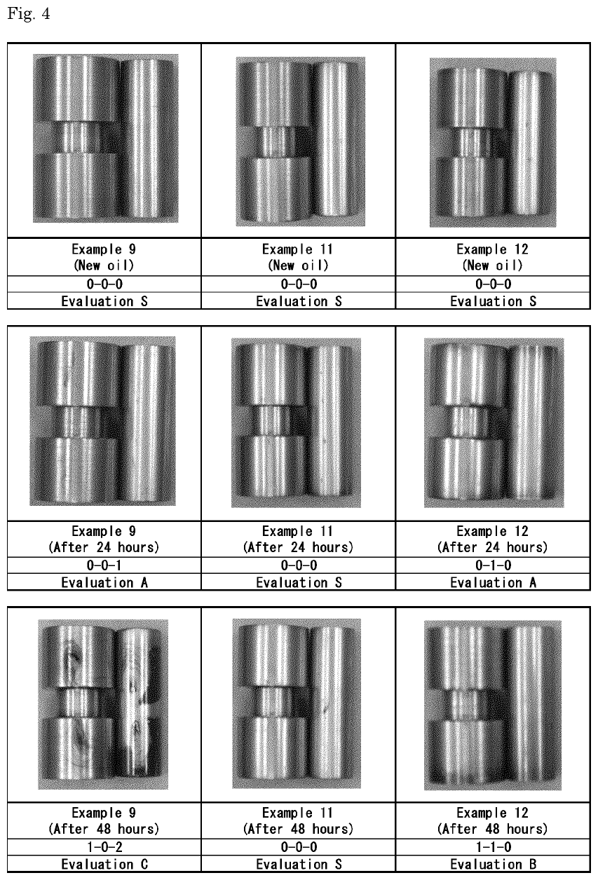

Table 3 shows the results of the measurement of the 40° C. kinematic viscosity and the evaluation of the brightness for the heat treating oil compositions of Examples 9, 11, and 12. Table 3 shows the results of the new oils, the results of the oil after subjecting to the 24-hour oxidative degradation test, and the results of the oil after subjecting to the 48-hour oxidative degradation test for the heat treating oil compositions. FIG. 4 shows the state of the test pieces after the quenching test using the heat treating oil compositions of Examples 9, 11, and 12.

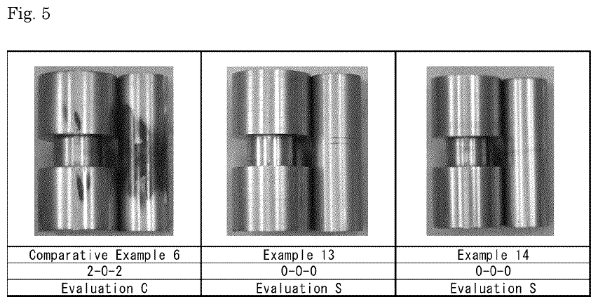

Table 4 shows the results of the evaluation of the brightness for the heat treating oil compositions of Comparative Example 6 and Examples 13 and 14. FIG. 5 shows the state of the test pieces after the quenching test using the heat treating oil compositions of Comparative Example 6, and Examples 13 and 14.

In Tables 1 and 2. “>” means “less than”.

TABLE 1

| | | | | | Example | | | | | |
|---|---|---|---|---|---|---|---|---|---|---|
| | | | | Unit | 1 | 2 | 3 | 4 | 5 | 6 |
| Composition | Base oil | Mineral oil (A1)-1 | | % by | 99.80 | 99.80 | 99.80 | 99.80 | 99.80 | 99.80 |
| of heat | (A) | | | mass | | | | | | |
| treating oil | Sulfur | Sulfide | 2,2′-Thiodiethylbis[3- | % by | 0.20 | — | — | — | — | — |
| composition | compound | compound | (3,5-di-tert-butyl-4- | mass | | | | | | |
| | (B) | (B1)-1 | hydroxyphenyl)propionate] | | | | | | | |
| | | Sulfide | Didodecyl 3,3′- | % by | — | 0.20 | — | — | — | — |
| | | compound | thiodipropionate | mass | | | | | | |
| | | (B1)-2 | | | | | | | | |
| | | Thiazole | 2-Methylbenzothiazole | % by | — | — | 0.20 | — | — | — |
| | | compound | | mass | | | | | | |
| | | (B3)-1 | | | | | | | | |
| | | Thiazole | 2-Methyl-4,5- | % by | — | — | — | 0.20 | — | — |
| | | compound | diphenylthiazole | mass | | | | | | |
| | | (B3)-2 | | | | | | | | |
| | | Thiazole | 2-Methylnaphtho[1,2- | % by | — | — | — | — | 0.20 | — |
| | | compound | d]thiazole | mass | | | | | | |
| | | (B3)-3 | | | | | | | | |
| | | Thiazole | 2-(2-Hydroxy- | % by | — | — | — | — | — | 0.20 |
| | | compound | phenyl)benzothiazole | mass | | | | | | |
| | | (B3)-4 | | | | | | | | |
| | | Thiazole | 2-Ethyl-4- | % by | — | — | — | — | — | — |
| | | compound | methylthiazole | mass | | | | | | |
| | | (B3)-5 | | | | | | | | |
| | | Thiazole | 2-Phenylbenzothiazole | % by | — | — | — | — | — | — |
| | | compound | | mass | | | | | | |
| | | (B3)-6 | | | | | | | | |
| | Comparative | Sulfur | 4,4′-Thiobis(6-tert- | % by | — | — | — | — | — | — |
| | sulfur | compound | butyl-m-cresol) | mass | | | | | | |
| | compound | (B′)-1 | | | | | | | | |
| | (B′) | Sulfur | Diphenylsulfone | % by | — | — | — | — | — | — |
| | | compound | | mass | | | | | | |
| | | (B′)-2 | | | | | | | | |

| | | | | | | | |
|---|---|---|---|---|---|---|---|
| Total | % by | 100.00 | 100.00 | 100.00 | 100.00 | 100.00 | 100.00 |
| | mass | | | | | | |

| | | | | | | | | |
|---|---|---|---|---|---|---|---|---|
| Property values of heat treating oil composition | Sulfur content | ppm by | 99 | 124 | 429 | 255 | 321 | 282 |
| | | mass | | | | | | |
| | 40° C. Kinematic viscosity | mm²/s | 396.7 | 396.5 | 396.6 | 396.7 | 396.6 | 396.7 |

| Evaluation result | [coloration degree]-[coloration at | — | 0-0-0 | 1-0-0 | 0-0-0 | 0-0-0 | 0-0-0 | 0-0-0 |
|---|---|---|---|---|---|---|---|---|
| of brightness | edge]-[coloration at contact site] | | | | | | | |
| | Total evaluation | — | S | A | S | S | S | S |

| | | | | | | | |
|---|---|---|---|---|---|---|---|
| Storage stability (one month) | — | good | good | good | good | good | good |

| | | | | | Example | | Comparative Example | | |
|---|---|---|---|---|---|---|---|---|---|
| | | | | Unit | 7 | 8 | 1 | 2 | 3 |
| Composition | Base oil | Mineral oil (A1)-1 | | % by | 99.80 | 99.80 | 100.00 | 99.80 | 99.80 |
| of heat | (A) | | | mass | | | | | |
| treating oil | Sulfur | Sulfide | 2,2′-Thiodiethylbis[3- | % by | — | — | — | — | — |
| composition | compound | compound | (3,5-di-tert-butyl-4- | mass | | | | | |
| | (B) | (B1)-1 | hydroxyphenyl)propionate] | | | | | | |
| | | Sulfide | Didodecyl 3,3′- | % by | — | — | — | — | — |
| | | compound | thiodipropionate | mass | | | | | |
| | | (B1)-2 | | | | | | | |
| | | Thiazole | 2-Methylbenzothiazole | % by | — | — | — | — | — |
| | | compound | | mass | | | | | |
| | | (B3)-1 | | | | | | | |
| | | Thiazole | 2-Methyl-4,5- | % by | — | — | — | — | — |
| | | compound | diphenylthiazole | mass | | | | | |
| | | (B3)-2 | | | | | | | |
| | | Thiazole | 2-Methylnaphtho[1,2- | % by | — | — | — | — | — |
| | | compound | d]thiazole | mass | | | | | |
| | | (B3)-3 | | | | | | | |
| | | Thiazole | 2-(2-Hydroxy- | % by | — | — | — | — | — |
| | | compound | phenyl)benzothiazole | mass | | | | | |
| | | (B3)-4 | | | | | | | |
| | | Thiazole | 2-Ethyl-4- | % by | 0.20 | — | — | — | — |
| | | compound | methylthiazole | mass | | | | | |
| | | (B3)-5 | | | | | | | |
| | | Thiazole | 2-Phenylbenzothiazole | % by | — | 0.20 | — | — | — |
| | | compound | | mass | | | | | |
| | | (B3)-6 | | | | | | | |
| | Comparative | Sulfur | 4,4′-Thiobis(6-tert- | % by | — | — | — | 0.20 | — |
| | sulfur | compound | butyl-m-cresol) | mass | | | | | |
| | compound | (B′)-1 | | | | | | | |
| | (B′) | Sulfur | Diphenylsulfone | % by | — | — | — | — | 0.20 |
| | | compound | | mass | | | | | |
| | | (B′)-2 | | | | | | | |

| | | | | | | |
|---|---|---|---|---|---|---|
| Total | % by | 100.00 | 100.00 | 100.00 | 100.00 | 100.00 |
| | mass | | | | | |

| | | | | | | | |
|---|---|---|---|---|---|---|---|
| Property values of heat treating oil composition | Sulfur content | ppm by | 504 | 303 | 3> | 278 | 269 |
| | | mass | | | | | |
| | 40° C. Kinematic viscosity | mm²/s | 396.5 | 396.7 | 396.7 | 396.6 | 396.7 |

| | | | | | | | |
|---|---|---|---|---|---|---|---|
| Evaluation result | [coloration degree]-[coloration at | — | 0-0-0 | 0-0-0 | 2-0-2 | 0-0-0 | 0-0-0 |
| of brightness | edge]-[coloration at contact site] | | | | | | |

| | | | | | | |
|---|---|---|---|---|---|---|
| Total evaluation | — | S | S | C | S | S |

| | | | | | | |
|---|---|---|---|---|---|---|
| Storage stability (one month) | — | good | good | good | light | light |

TABLE 2

| | | | | | Comparative Example | | Example | |
|---|---|---|---|---|---|---|---|---|
| | | | | Unit | 4 | 5 | 9 | 10 |
| Composition | Base oil (A) | Mineral oil (A1)-2 | | % by mass | 46.00 | 45.80 | 45.80 | 45.80 |
| of heat | | Mineral oil (A1)-3 | | % by mass | 30.00 | 30.00 | 30.00 | 30.00 |
| treating oil | | Mineral oil (A1)-4 | | % by mass | 20.00 | 20.00 | 20.00 | 20.00 |
| composition | Sulfur | Sulfide | 2,2′-Thiodiethylbis[3- | % by mass | — | — | 0.20 | — |
| | compound (B) | compound | (3,5-di-tert-butyl-4- | | | | | |
| | | (B1)-1 | hydroxyphenyl)propionate] | | | | | |
| | | Thiazole | 2-Methylbenzothiazole | % by mass | — | — | — | 0.20 |
| | | compound | | | | | | |
| | | (B3)-1 | | | | | | |
| | Comparative | Thiophene | Dibenzothiophene | % by mass | — | 0.20 | — | — |
| | sulfur | compound | | | | | | |
| | compound (B′) | (B′)-3 | | | | | | |

| | | | | | | |
|---|---|---|---|---|---|---|
| Additive | Vapor blanket collapse agent | % by mass | 3.00 | 3.00 | 3.00 | 3.00 |
| | Brightness improver | % by mass | 1.00 | 1.00 | 1.00 | 1.00 |

| | | | | | |
|---|---|---|---|---|---|
| Total | % by mass | 100.00 | 100.00 | 100.00 | 100.00 |

| | | | | | | |
|---|---|---|---|---|---|---|
| Property values of heat treating oil composition | Sulfur content | ppm by mass | 3> | 347 | 97 | 431 |

| New oil | 40° C. Kinematic viscosity | | mm²/s | 18.08 | 18.06 | 18.17 | 17.64 |
|---|---|---|---|---|---|---|---|
| | Evaluation result | [coloration degree]-[coloration at | — | 2-0-2 | 0-0-0 | 0-0-0 | 0-0-0 |
| | of brightness | edge]-[coloration at contact site] | | | | | |
| | | Total evaluation | — | C | S | S | S |
| After 24-hour | 40° C. Kinematic viscosity | | mm²/s | 28.05 | 27.78 | 23.94 | 21.73 |
| oxidative | Increment rate of 40° C. kinematic viscosity from new oil | | % | 55.14 | 53.82 | 31.76 | 23.19 |
| degradation | Evaluation result | [coloration degree]-[coloration at | — | 2-0-2 | 2-0-2 | 0-0-1 | 0-0-1 |
| test | of brightness | edge]-[coloration at contact site] | | | | | |
| | | Total evaluation | — | C | C | A | A |

TABLE 3

| | | | | | Example | | |
|---|---|---|---|---|---|---|---|
| | | | | Unit | 9 | 10 | 11 |
| Composition | Base oil (A) | Mineral oil (A1)-2 | | % by mass | 45.80 | 45.70 | 45.70 |
| of heat | | Mineral oil (A1)-3 | | % by mass | 30.00 | 30.00 | 30.00 |
| treating oil | | Mineral oil (A1)-4 | | % by mass | 20.00 | 20.00 | 20.00 |
| composition | Sulfur | Sulfide | 2,2′-Thiodiethylbis[3- | % by mass | 0.20 | 0.20 | 0.20 |
| | compound (B) | compound | (3,5-di-tert-butyl-4- | | | | |
| | | (B1)-1 | hydroxyphenyl)propionate] | | | | |

| | | | | | |
|---|---|---|---|---|---|
| Additive | Vapor blanket collapse agent | % by mass | 3.00 | 3.00 | 3.00 |
| | Brightness improver | % by mass | 1.00 | 1.00 | 1.00 |

| | | | | | |
|---|---|---|---|---|---|
| Antioxidant | Amine-based antioxidant | % by mass | — | 0.10 | — |
| | Phenol-based antioxidant | % by mass | — | — | 0.10 |

| | | | | |
|---|---|---|---|---|
| Total | % by mass | 100.00 | 100.00 | 100.00 |

| | | | | | |
|---|---|---|---|---|---|
| Property values of heat treating oil composition | Sulfur content | ppm by mass | 97 | 99 | 99 |

| New oil | 40° C. Kinematic viscosity | | mm²/s | 18.17 | 18.21 | 18.19 |
|---|---|---|---|---|---|---|
| | Evaluation result | [coloration degree]-[coloration at | — | 0-0-0 | 0-0-0 | 0-0-0 |
| | of brightness | edge]-[coloration at contact site] | | | | |
| | | Total evaluation | — | S | S | S |
| After 24-hour | 40° C. Kinematic viscosity | | mm²/s | 23.94 | 19.43 | 18.79 |
| oxidative | Increment rate of 40° C. kinematic viscosity from new oil | | % | 31.76 | 6.70 | 3.30 |
| degradation | Evaluation result | [coloration degree]-[coloration at | — | 0-0-1 | 0-0-0 | 0-1-0 |
| test | of brightness | edge]-[coloration at contact site] | | | | |
| | | Total evaluation | — | A | S | A |
| After 48-hour | 40° C. Kinematic viscosity | | mm²/s | 40.19 | 22.63 | 19.13 |
| oxidative | Increment rate of 40° C. kinematic viscosity from new oil | | % | 121.19 | 24.27 | 5.17 |
| degradation | Evaluation result | [coloration degree]-[coloration at | — | 1-0-2 | 0-0-0 | 1-1-0 |
| test | of brightness | edge]-[coloration at contact site] | | | | |
| | | Total evaluation | — | C | S | B |

TABLE 4

| | | | | | Comparative | | |
|---|---|---|---|---|---|---|---|
| | | | | | Example | Example | |
| | | | | Unit | 6 | 13 | 14 |
| Composition | Base oil (A) | Mineral oil (A1)-5 | | % by mass | 88.30 | 88.00 | 88.00 |
| of heat | | Mineral oil (A1)-6 | | % by mass | 7.00 | 7.00 | 7.00 |
| treating oil | Sulfur | Sulfide | 2,2′-Thiodiethylbis[3- | % by mass | — | 0.30 | — |
| composition | compound (B) | compound (B1)-1 | (3,5-di-tert-butyl-4- | | | | |
| | | | hydroxyphenyl)propionate] | | | | |
| | | Thiazole | 2-Methylbenzothiazole | % by mass | — | — | 0.30 |
| | | compound (B3)-1 | | | | | |

| | | | | | |
|---|---|---|---|---|---|
| Additive | Vapor blanket collapse agent | % by mass | 3.00 | 3.00 | 3.00 |
| | Brightness improver | % by mass | 1.50 | 1.50 | 1.50 |

| | | | | | |
|---|---|---|---|---|---|
| Antioxidant | Phenol-based antioxidant | % by mass | 0.20 | 0.20 | 0.20 |

| | | | | |
|---|---|---|---|---|
| Total | % by mass | 100.00 | 100.00 | 100.00 |

| | | | | | |
|---|---|---|---|---|---|
| Property values of heat treating oil composition | Sulfur content | % by mass | 0.07 | 0.08 | 0.13 |
| | 40° C. Kinematic viscosity | mm²/s | 18.88 | 18.48 | 18.01 |

| | | | | | |
|---|---|---|---|---|---|
| Evaluation result of brightness | [coloration degree]-[coloration at | — | 2-0-2 | 0-0-0 | 0-0-0 |
| | edge]-[coloration at contact site] | | | | |
| | Total evaluation | — | C | S | S |

The following matters are understood from Table 1.

It is understood from the results shown by Examples 1 to 8 that the heat treating oil composition containing the sulfide compound (B1), the sulfide compound (B2), or the thiazole compound (B3) as the sulfur compound (B) is excellent in brightness of the test piece after quenching, and also is excellent in storage stability.

On the other hand, it is understood from the results shown by Comparative Examples 2 and 3 that the heat treating oil composition containing the sulfur compound (B′)-1, which is a sulfide compound having no ester structure, or the sulfur compound (B′)-2, which is a sulfone compound, is excellent in brightness of the test piece after quenching, but is inferior in storage stability.

The following matters are understood from Table 2.

It is understood from the results shown by Examples 9 and 10 that the heat treating oil composition containing the sulfide compound (B1) or the thiazole compound (B3) as the sulfur compound (B) is excellent in brightness of the test piece after quenching not only in the state of new oil but also after the 24-hour oxidative degradation test.

On the other hand, it is understood from the results shown by Comparative Example 5 that the heat treating oil composition containing the sulfur compound (B′)-3, which is a thiophene compound, is excellent in brightness of the test piece after quenching in the state of new oil, but is inferior in brightness of the test piece after quenching after the 24-hour oxidative degradation test.

It is also understood that the heat treating oil composition of Comparative Example 5 has a 40° C. kinematic viscosity after the 24-hour oxidative degradation test that is significantly increased as compared to the heat treating oil compositions of Examples 9 and 10, and thus likely undergo oxidative degradation (i.e., has low oxidation stability).

The following matters are understood from Table 3.

It is understood from the results shown by Examples 9, 11, and 12 that the antioxidant blended therein as in the heat treating oil compositions of Examples 11 and 12 provides excellent brightness of the test piece after quenching even after 48-hour oxidative degradation test.

It is also understood that the heat treating oil composition of Example 9 having no antioxidant blended therein has a 40° C. kinematic viscosity after the oxidative degradation test that is significantly increased as compared to the heat treating oil compositions of Examples 11 and 12 having the antioxidant blended therein, and thus likely undergo oxidative degradation (i.e., has low oxidation stability).

The following matters are understood from Table 4.

It is understood from the results shown by Examples 13 and 14 that the heat treating oil composition containing the sulfide compound (B1) or the thiazole compound (B3) is excellent in brightness of the test piece after quenching even in the case where the heating temperature is as significantly high as 975° C.

1. A heat treating oil composition comprising
a base oil (A) selected from the group consisting of a mineral oil (A1), a synthetic oil (A2), and a vegetable oil (A3), and
a sulfur compound (B), the sulfur compound (B) comprising a compound selected from the group consisting of a sulfide compound (B1) represented by the following formula (b1), a sulfide compound (B2) represented by the following formula (b2), and a thiazole compound (B3) represented by the following formula (b3): 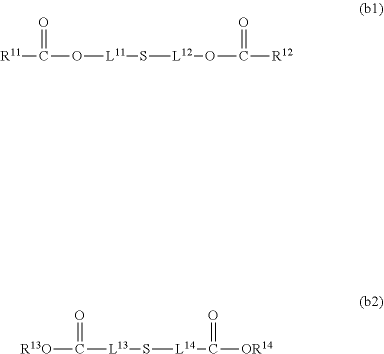
wherein in the formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the formulae (b1) and (b2), L¹¹, L¹², L¹³, and L¹⁴ each independently represent an alkylene group having 2 to 6 carbon atoms, 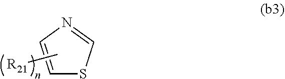
wherein in the formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and n represents an integer of 0 to 3, in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.

2. The heat treating oil composition according to claim 1, wherein in the formula (b1), the hydrocarbon group (X) of at least one of R¹¹ and R¹² is an aryl group having 6 to 20 carbon atoms or an arylalkyl group having 7 to 20 carbon atoms.

3. The heat treating oil composition according to claim 1, wherein the sulfide compound (B1) comprises a sulfide compound (B1-1) represented by the following formula (b1-1): 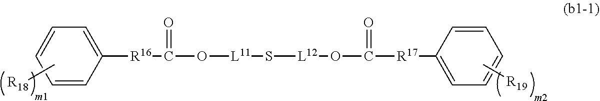
wherein in the formula (b1-1), R¹⁶ and R¹⁷ each independently represent an alkylene group having 1 to 6 carbon atoms, L¹¹ and L¹² each independently represent an alkylene group having 2 to 6 carbon atoms, R¹⁸ and R¹⁹ each independently represent an alkyl group having 1 to 10 carbon atoms or a hydroxy group, m1 represents an integer of 0 to 5, m2 represents an integer of 0 to 5, in the case where m1 represents 2 or more, multiple groups represented by R¹⁸ may be the same as or different from each other, and in the case where m2 represents 2 or more, multiple groups represented by R¹⁹ may be the same as or different from each other.

4. The heat treating oil composition according to claim 1, wherein the thiazole compound (B3) has a molecular skeleton represented by the following structural formula (b3α) or the following structural formula (b3β):

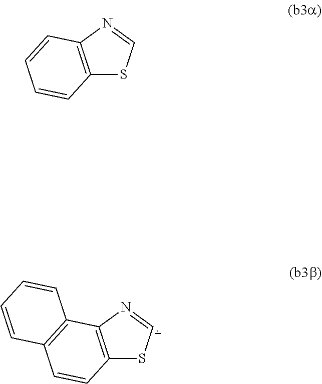 [SMILES: c1ccc2scnc2c1 ; c1ccc2c(c1)ccc1scnc12]

5. The heat treating oil composition according to claim 1, wherein the heat treating oil composition has a sulfur content of 10 ppm by mass to 5,000 ppm by mass based on the total amount of the heat treating oil composition.

6. The heat treating oil composition according to claim 1, wherein the heat treating oil composition has a content of the sulfur compound (B) of 0.01% by mass to 2.0% by mass based on the total amount of the heat treating oil composition.

7. The heat treating oil composition according to claim 1, wherein the heat treating oil composition further comprises an additive selected from the group consisting of a vapor blanket collapse agent, a brightness improver, a coolability improver, and an antioxidant.

8. A quenching oil or tempering oil comprising
the heat treating oil composition according to claim 1.

9. A method of quenching or tempering a heated metal material, comprising:
immersing the heated metal material into the heat treating oil composition of claim 1.

10. A method of producing a heat treating oil composition, comprising:
mixing a base oil (A) selected from the group consisting of a mineral oil (A1), a synthetic oil (A2), and a vegetable oil (A3), and a sulfur compound (B), the sulfur compound (B) comprising a compound selected from the group consisting of a sulfide compound (B1) represented by the following formula (b1), a sulfide compound (B2) represented by the following formula (b2), and a thiazole compound (B3) represented by the following formula (b3): 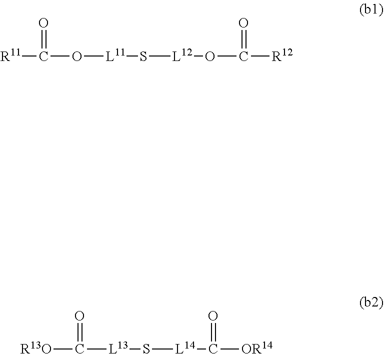
wherein in the formulae (b1) and (b2), R¹¹, R¹², R¹³, and R¹⁴ each independently represent a substituted or unsubstituted hydrocarbon group (X), in which the hydrocarbon group (X) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and
in the formulae (b1) and (b2), L¹¹, L¹², L¹³, and L¹⁴ each independently represent an alkylene group having 2 to 6 carbon atoms, 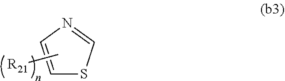
wherein in the formula (b3), R²¹ represents a substituted or unsubstituted hydrocarbon group (Y), in which the hydrocarbon group (Y) is an alkyl group having 1 to 20 carbon atoms, an alkenyl group having 2 to 20 carbon atoms, a cycloalkyl group having 3 to 20 carbon atoms, a cycloalkenyl group having 3 to 20 carbon atoms, a cycloalkylalkyl group having 4 to 20 carbon atoms, a cycloalkenylalkyl group having 4 to 20 carbon atoms, an aryl group having 6 to 20 carbon atoms, or an arylalkyl group having 7 to 20 carbon atoms, and n represents an integer of 0 to 3, in which in the case where n is 2 or more, multiple groups represented by R²¹ may be the same as or different from each other, and in the case where n is 2 or more, and two groups represented by R²¹ are adjacent to each other, the two groups represented by R²¹ may form a cyclic structure.
